(19) United States
(12) Patent Application Publication
(10) Pub. No.: US 2025/0057374 A1
(43) Pub. Date: Feb. 20, 2025

(54) SEPARATOR FOR A FLUID CLEANING DEVICE

(71) Applicant: Dyson Technology Limited, Malmesbury, Wiltshire (GB)

(72) Inventors: Mateusz GUGALA, Gloucester (GB); Stefan KOCH, Dorset (GB)

(21) Appl. No.: 18/720,783

(22) PCT Filed: Dec. 14, 2022
(86) PCT No.: PCT/GB2022/053223

§ 371 Date: Jun. 17, 2024

(30) Foreign Application Priority Data
Dec. 17, 2021 (GB) 2118388.4

(51) Int. Cl. A47L 9/10; A47L 9/16

(52) U.S. Cl. CPC A47L 9/104; A47L 9/165; A47L 9/1658

(57) ABSTRACT

A separator for a cleaning device, the separator comprising: a housing that encloses a separating volume, the housing comprising an inlet for receiving a fluid flow containing entrained debris into the separating volume, and an outlet for discharging a filtered fluid flow output from the separating volume; a filter screen disposed on or in the housing to define part of a boundary of the separating volume, the filter screen being configured to retain the debris in the separating volume while allowing air to exit the separating volume to flow to the outlet; and an extractor arrangement providing fluid communication between the separating volume and a low-pressure region of the separator that is at lower pressure than the separating volume, in use, such that fluid is drawn into the extractor arrangement from the separating volume.

### TECHNICAL FIELD

The invention relates to separators and separating processes for fluid cleaning devices.

### BACKGROUND

Many fluid cleaning devices implement cyclonic separation as an initial stage of purification, to remove the heaviest particles and/or debris from an incoming fluid flow. In the case of vacuum cleaning devices, a separator that implements cyclonic separation may replace a dust bag, in that the separator can be configured to remove and collect larger particulates and debris from an incoming flow of air. This creates a partially filtered flow, which may then be purified further by a fine dust separator and optionally additional filters such as a HEPA (high efficiency particulate air) filter, such that particulates of successively smaller sizes are removed from the flow to produce a purified output. When the separator is full it can be removed, emptied and returned to the device.

Various separator configurations are known, but typically a separator is defined by a hollow housing assembly that encloses an internal volume that is divided into two mutually-isolated chambers by a separating grid, which is also referred to as a ‘shroud’ or ‘mesh’. The mesh acts as a filter screen that allows fluid and particles below a certain size to pass between the chambers, whilst blocking larger particles and debris. Incoming air containing debris is delivered into a first of these chambers, which is therefore an upstream chamber that may be referred to as the ‘primary bin’, whilst the second, downstream chamber on the opposite side of the mesh, or ‘secondary bin’, which may be relatively small and in the form of a duct, the secondary bin being connected to an outlet that conveys a filtered flow on for further purification in additional separation stages. The first and second chambers may be arranged at opposite ends of the housing, or the chambers may be arranged concentrically, for example.

The separator is configured to generate a cyclonic flow in the primary bin that encourages heavier debris to accumulate in a region of the chamber that is spaced from the mesh. Meanwhile, fibres and other lightweight debris that remains in the rotating flow are prevented from passing through to the secondary bin by the mesh.

In existing arrangements, during operation debris accumulates on a surface of the mesh and lodges in pores of the mesh, progressively blocking the mesh and so increasing resistance to air flow through the mesh. Blocking of the mesh in this manner may also be referred to as ‘mesh blinding’. Blinding of the mesh in turn hinders performance of the device until the separator is removed and the mesh is cleaned. The separator may therefore have to be cleaned prematurely before the primary bin is full, which increases the level of user maintenance required. The rate at which the mesh blocks is related to the effectiveness with which debris is deposited at the intended accumulation point in the primary bin relative to the extent to which debris recirculates in the primary bin, in combination with the nature of debris that is being drawn into the separator.

One approach to reducing mesh blinding is to increase the pore size of the mesh to reduce the likelihood of blockage. However, increasing the pore size inevitably allows larger particles to pass through the mesh, to the detriment of the separation efficiency of the separator, namely the proportion of debris that is captured in the primary bin.

Another measure that is taken is to limit the size of an inlet to the primary bin through which incoming air is discharged, in turn ensuring that the velocity of the air flow into the primary bin is high for a given flow rate. This high flow velocity inside the primary bin helps to reduce mesh blinding, but at the cost of increased jetting losses within the primary bin and in turn increased power consumption for the device.

WO 2011/161591 proposes a separator arrangement that is configured to reduce mesh blinding by directing a main inlet air flow at the mesh of a separator, so that the mesh is kept clean by the air flow in use. However, the mesh is vulnerable to damage from large and/or heavy objects that may be entrained in the incoming air flow.

It is against this background that the present invention has been devised.

### SUMMARY OF THE INVENTION

An aspect of the invention provides a separator for a cleaning device. The separator comprises: a housing that encloses a separating volume, the housing comprising an inlet for receiving a fluid flow containing entrained debris into the separating volume, and an outlet for discharging a filtered fluid flow output from the separating volume; a filter screen disposed on or in the housing to define part of a boundary of the separating volume, the filter screen being configured to retain the debris in the separating volume while allowing air to exit the separating volume to flow to the outlet; and an extractor arrangement providing fluid communication between the separating volume and a low-pressure region of the separator that is at lower pressure than the separating volume, in use, such that fluid is drawn into the extractor arrangement from the separating volume.

The extractor arrangement may be defined by a duct arrangement comprising a network of one or more ducts, for example. By connecting to the low-pressure region, the extractor arrangement generates suction in the separating volume that pulls fluid out from the separating volume and into the extractor arrangement. This suction can be used to control movement of debris within the separating volume and to promote depositing of debris in an area away from the filter screen. This, in turn, helps to reduce accumulation of debris on the filter screen and therefore improves the performance of the separator.

The low-pressure region may be defined by a constricted channel that is configured to generate a pressure drop, in use, for example as a venturi arrangement. Alternatively, the low-pressure region may be defined by an area disposed on a downstream side of the filter screen, in which case the extractor arrangement may provide a bypass connection between the separating volume and the area downstream of the filter screen.

In a further alternative, the extractor arrangement is connected or connectable to a suction device that is configured to draw fluid from the separating volume through the extractor arrangement, so that the extractor arrangement comprises the low-pressure region.

The separator may comprise a spout that is connected to the inlet, the spout comprising a spout outlet through which the fluid flow is discharged into the separating volume. The spout may extend into the separating volume from the inlet. Alternatively the spout outlet may define the inlet of the housing.

The spout may form part of the extractor arrangement. For example, the spout may comprise the constricted channel, in that the spout may be configured with a constriction that forms a venturi arrangement that generates a pressure drop, in use. This pressure drop creates the low-pressure region, and in turn generates the suction required to pull air into the extractor arrangement from the separating volume. In such arrangement, fluid is recirculated from the primary bin, through the spout and back into the primary bin. This increases the total flow rate of fluid into the primary bin, which may help to keep the filter screen clear of debris.

The extractor arrangement may connect to the separating chamber through an intake that is spaced longitudinally from the filter screen, and optionally multiple such intakes. The intake may be disposed at or near a longitudinal end of the separating chamber. Since the intake defines the point at which suction is generated in the separating volume, positioning the intakes in this way beneficially promotes depositing of debris away from the filter screen. Also, debris accumulating in the primary bin may progressively cover the intake, thereby further filtering the fluid that is drawn into the extractor arrangement.

More generally, the extractor arrangement may be arranged to promote accumulation of debris in a region of the separating volume that is spaced from the filter screen, for example at a longitudinal end of the separating volume.

The separator may comprise one or more filters that are arranged to prevent debris from entering the extractor arrangement.

The extractor arrangement may define or forms part of a vacuum ejector.

The extractor arrangement optionally comprises a cleaning conduit that is configured to convey fluid towards the filter screen, the cleaning conduit comprising a jet-forming outlet that is configured to direct a fluid jet at or across the filter screen to remove debris attached to the filter screen.

The spout may be configured to direct the fluid flow across the filter screen. For example, the spout may be configured to direct the fluid flow in a direction that is at an angle of less than 10° with respect to the filter screen, and optionally in a direction that is substantially parallel to the filter screen.

More generally, directing the fluid flow across the screen entails ensuring that an axis corresponding to the direction of the flow does not intersect any part of the screen, such that the fluid does not flow directly at any part of the screen. This in turn ensures that any objects entrained in the flow are not carried into the screen, thereby avoiding a risk of damage to the screen from larger objects.

Directing the fluid flow across the screen also typically entails directing the flow such that the screen defines a boundary of the flow, so that a surface of the screen is exposed to the moving fluid. This enables the fluid flow to clear the screen of particles and debris continuously in use by aerodynamic scrubbing, thereby reducing blinding of the screen. In some embodiments, however, the flow is directed such that it is slightly spaced from the screen, whilst still being generally parallel to the screen, to create a protective curtain across the screen that diverts debris away from the screen.

The spout may be curved along at least part of its length, which may shape the incoming fluid flow to correspond to the shape of the filter screen and may help to reduce blocking of the spout in use. The spout optionally curves in mutually opposed directions.

More generally, the spout may be configured to shape the discharged fluid flow in accordance with the geometry of the filter screen. In this respect, configuring the spout to shape the flow may include tuning or otherwise determining one or more of: the longitudinal profile of the spout; the cross-sectional area of the spout; the cross-sectional shape of the spout; the size of the spout outlet; and the shape of the spout outlet. In one embodiment, for example, the spout outlet is trapezoidal.

The spout may extend into the separating volume from the inlet. Alternatively, the spout outlet may define the inlet of the housing, for example where the spout is at least partially external to the separating volume.

The separator may be configured to establish a secondary flow that circulates around the separating volume. Such a secondary flow may encourage debris to accumulate in a base region of the separating volume away from the filter screen.

Optionally, the inlet and the outlet are disposed at opposed longitudinal ends of the housing, which can provide a compact design.

The filter screen may be oriented at an oblique angle relative to a longitudinal axis of the housing. This may aid guidance of flow within the separating volume and increases the size of the screen that can be used for a housing of a given width or diameter. The filter screen may be oriented at an angle of between 35° and 55°, and optionally at approximately 45° with respect to the longitudinal axis of the housing, for example. The spout outlet may be positioned at or near to an end of the filter screen that is closest to the inlet.

The filter screen may comprise a mesh having a minimum pore size of 250 microns, and optionally 100 microns.

The inlet may define an inlet axis that is parallel to a longitudinal axis of the housing. Similarly, the outlet may define an outlet axis that is parallel to a longitudinal axis of the housing.

The separator may comprise an underslung fine dust collector within the housing. For example, the fine dust collector may extend downwardly from an upper end of the housing. Accommodating the fine dust collector in this way may provide for a compact design and may allow the fine dust collector and the separating volume to be accessible through a common opening of the housing such that they can be emptied in a single operation, for example.

The filter screen may be generally planar. Alternatively, the screen may curve around one or more axes of curvature.

The housing is optionally formed from multiple parts.

The invention also extends to a cleaning device comprising the separator of the above aspect. Such a device may be embodied as a domestic appliance, for example.

Another aspect of the invention provides a method of reducing blockage of a filter screen of a separator for a cleaning device. The filter screen is disposed on or in a housing of the separator to define part of a boundary of a separating volume enclosed by the housing. The housing comprises an inlet for receiving a fluid flow containing entrained debris into the separating volume and an outlet for discharging a filtered fluid flow output from the separating volume. The method comprises establishing fluid communication between the separating volume and a low-pressure region of the separator that is at lower pressure than the separating volume, in use, to define an extractor arrangement into which fluid is drawn from the separating volume.

It will be appreciated that preferred and/or optional features of each aspect of the invention may be incorporated alone or in appropriate combination in the other aspects of the invention also.

### BRIEF DESCRIPTION OF THE DRAWINGS

One or more embodiments of the invention will now be described, by way of example only, with reference to the accompanying drawings, in which like features are assigned like numerals, and in which:

FIG. 1 is top view of a separator;

FIG. 2 is an axial cross-sectional view of the separator taken through the line A-A in FIG. 1;

FIG. 3 is an axial cross-sectional view of the separator taken through the line B-B in FIG. 1;

FIG. 4 is a radial cross-sectional view of the separator taken through line C-C in FIG. 2;

FIGS. 5a to 5c show perspective views of the separator of FIG. 1 with portions of a housing of the separator hidden;

FIG. 6 corresponds to FIG. 2 but shows air flow inside the separator in use;

FIG. 7 corresponds to FIG. 2 but shows an alternative separator;

FIG. 8 corresponds to FIG. 3 but shows the separator of FIG. 7;

FIGS. 9a to 9c are schematic representations of alternative separator layouts;

FIG. 10 shows a perspective view of an alternative separator that includes a jet forming arrangement;

FIG. 11 is a detail view of a spout outlet region of the separator of FIG. 10;

FIG. 12 is an axial cross-section view of the separator of FIG. 10;

FIG. 13 an axial cross-sectional view of the separator taken through the line E-E in FIG. 12;

FIG. 14 is a radial cross-sectional view of the separator taken through line G-G in FIG. 12;

FIG. 15 is a radial cross-sectional view of the separator taken through line F-F in FIG. 12;

FIGS. 16a to 16d show a variant of the separator of FIG. 10;

FIG. 17 shows a perspective view of an alternative separator that includes an alternative jet forming arrangement;

FIG. 18 is a top view of the separator of FIG. 17;

FIG. 19 is an axial cross-section view of the separator taken through the line H-H in FIG. 18;

FIG. 20 is an axial cross-sectional view of the separator taken through the line J-J in FIG. 19;

FIG. 21 is a radial cross-sectional view of the separator taken through line K-K in FIG. 19;

FIG. 22 is a detail view of a spout outlet of the separator of FIG. 20, showing the spout outlet in a partially open state;

FIG. 23 corresponds to FIG. 22 but shows the spout outlet in a closed state;

FIG. 24 corresponds to FIG. 19 but shows the spout outlet in a fully open state;

FIG. 25 corresponds to FIG. 20 but shows the spout outlet in a fully open state;

FIG. 26 corresponds to FIG. 23 but shows the spout outlet in a fully open state;

FIG. 27 shows a variant of the separator of FIG. 17;

FIGS. 28a to 28c are detail views of a sliding spout cover shown in FIG. 27 in different positions;

FIG. 29 is an axial cross-sectional view of the separator of FIG. 27;

FIGS. 30a and 30b show detail views of the sliding spout cover shown in FIG. 29 in different positions;

FIG. 31 corresponds to FIG. 29 but shows the sliding spout cover in a stowed position;

FIG. 32 is a detail view of the sliding spout cover of FIG. 31;

FIGS. 33a and 33b show an alternative closure arrangement for the spout of the separator of FIG. 17;

FIG. 34 shows a perspective view of an alternative separator that includes an extractor arrangement;

FIG. 35 is a front view of the separator of FIG. 34;

FIG. 36 is a top view of a first variant of the separator of FIG. 34;

FIG. 37 is an axial cross-sectional view of the separator taken through the line H-H in FIG. 36;

FIG. 38 is an axial cross-sectional view of the separator taken through the line J-J in FIG. 37;

FIG. 39 is a radial cross-sectional view of the separator taken through the line K-K in FIG. 37;

FIG. 40 is a top view of a second variant of the separator of FIG. 34;

FIG. 41 is an axial cross-sectional view of the separator taken through the line H-H in FIG. 40;

FIG. 42 is an axial cross-sectional view of the separator taken through the line J-J in FIG. 41; and

FIG. 43 is a radial cross-sectional view of the separator taken through the line K-K in FIG. 41.

### DETAILED DESCRIPTION

In general terms, embodiments of the invention provide separators for fluid cleaning devices that are configured for reduced mesh blinding and low pressure consumption relative to known arrangements. The embodiments described below are configured for use in domestic vacuum cleaning devices, but it will be appreciated that other embodiments of the invention are applicable to a range of cleaning devices.

In embodiments to be described, separators for vacuum cleaning devices are configured with extractor arrangements that connect a separating volume defined by an upstream chamber, or ‘primary bin’, of the separator to an area of low pressure through suitable ducting, thereby generating suction that pulls air from the primary bin and into the extractor arrangement. This suction can be used to control movement of debris within the primary bin, and to promote depositing and compaction of debris in a particular region that is spaced from the mesh, typically at the bottom of the primary bin. This avoids chaotic movement and recirculation of debris in the primary bin, and thereby improves separation efficiency. This, in turn, reduces the rate at which debris accumulates on the mesh and thus reduces mesh blinding.

In some embodiments, the extractor arrangement complements a primary inlet flow into the primary bin that is directed across the mesh to create a protective curtain across the mesh that acts as a barrier to prevent debris from reaching the mesh. The primary inlet flow instead directs any debris along and then away from the mesh, to accumulate in another part of the primary bin. The relative flow rates across and through the mesh in part determine the effectiveness with which dust is separated and retained in the primary bin, including separation of particles that are of a size that can pass through the mesh.

Although the primary inlet flow is not directed at the mesh, this flow across the mesh may also remove and/or dislodge any particles that do attach to the mesh by generating high shear stress between the air flow and the particles, which creates an aerodynamic scrubbing effect that captures particles from the surface of the mesh. Accordingly, the air flow provides aerodynamic wiping of the mesh that minimises the level of manual cleaning of the mesh that may be required and ensures that the mesh does not blind significantly before the primary bin is full.

The separator may also include a jet forming arrangement comprising a cleaning conduit that is configured to form a high-speed fluid flow defining a cleaning jet, which is directed at or across the mesh to clear the mesh. In this respect, directing the jet across the mesh entails discharging the jet into the primary bin in a direction that is parallel, or close to parallel, to the mesh, and often-but not always-sufficiently close to the mesh that a surface of the mesh defines a boundary of the air flow. Such a jet can have high momentum, or dynamic pressure, which pushes debris away from the mesh and into the primary bin, to unblock the mesh to some extent.

The jet can be activated, when necessary, to clear any debris that accumulates on the mesh despite the washing provided by the primary inlet flow, thereby enhancing clearing of the mesh. Accordingly, the primary inlet air flow provides long-term low-power aerodynamic wiping of the mesh, whereas the cleaning jet provides short-term high-power wiping of the mesh.

The cleaning jet may therefore emulate the functionality provided by mechanical wiping mechanisms in other arrangements. Such mechanisms can have poor reliability due to the use of moving parts in the dusty environments in which they operate. In contrast, the cleaning jet of embodiments of the invention can be implemented without moving parts and are as such less susceptible to problems caused by dust ingress.

The use of the extractor arrangement, optionally alongside continuous washing of the mesh using the incoming air flow and a cleaning jet, may allow the pore size of the mesh to be reduced relative to known arrangements that use larger pore sizes to reduce blinding. Reducing the pore size in turn enhances the separation efficiency of the separator.

Conversely, the shapes of the pores become increasingly significant to separation performance in arrangements in which a primary inlet flow is directed across the mesh, particularly the profiles of the leading edges of the pores with respect to the flow direction of the incoming air flow. In this respect, laser cut pores having straight edges and sharp corners may perform less effectively than electro-formed pores with more curved profiles facing the flow, for example.

Another benefit of embodiments of the invention is that, because the mesh is kept clear by the extractor arrangement, the inlet through which air enters the primary bin can be made larger, such that the velocity of the inlet flow is lower than in existing designs for a given flow rate. This reduced velocity in turn reduces jetting losses inside the primary bin, which is typically one of the dominant losses in a separator. Accordingly, reducing the jetting losses offers a significant improvement in the overall efficiency of the device.

Similarly, the device can achieve the same efficiency as known arrangements whilst consuming less power.

Although the direction of the inlet air flow may not be precisely parallel to the mesh, for example being within 10° of a plane or tangent of the mesh, advantageously the inlet air flow is typically not directed at any part of the mesh and so any larger particles entrained in the air flow that could pose a threat of damage to the mesh are not carried into the mesh

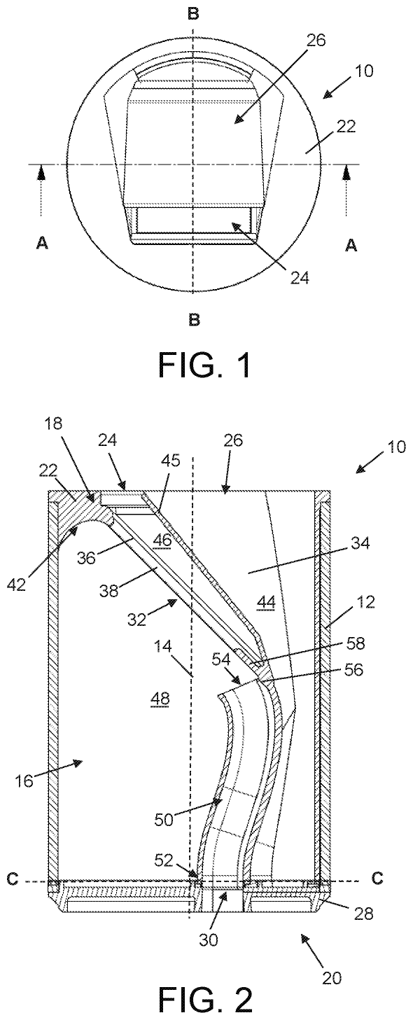

Embodiments of the invention are described in more detail later. First, to provide context for the invention FIGS. 1 to 9 show separators in which embodiments of the invention may be implemented, the separators being for use in a device such as a domestic cleaning appliance. FIGS. 1 to 9 are therefore used to describe the general layout of the separators, before moving on to consider the specific features used to implement the principles of the invention that are shown in the later figures. It is noted that embodiments of the invention may also be implemented in different types of separator to those shown in FIGS. 1 to 9. More generally, it is reiterated that the principles of the invention may be used in a range of contexts.

Starting with FIGS. 1 to 6, which are now described collectively, a separator 10 is shown that comprises a casing 12 defined by a tubular wall of circular cross section as shown in FIG. 1. The wall of the casing 12 encircles a central axis 14 to enclose a cylindrical interior volume 16, the central axis 14 also defining a central longitudinal axis of the separator 10. The casing 12 is configured for use with its central axis 14 oriented vertically as shown in FIG. 2, such that the casing 12 has an upper end and a lower end, the upper and lower ends being at opposed longitudinal ends of the casing 12. It is noted that casings of various shapes may be used in embodiments of the invention, however, including cuboidal casings for example.

The upper end of the casing 12 receives and is closed by an upper separator assembly 18. Correspondingly, the lower end of the casing 12 is closed by a lower separator assembly 20. The casing 12, the upper separator assembly 18 and the lower separator assembly 20 therefore collectively define a housing of the separator 10 that contains the interior volume 16.

The upper separator assembly 18 includes a generally circular upper support plate 22 that is shaped and dimensioned to engage the upper end of the casing 12, for example in a press fit. In this respect, the upper support plate 22 has an upper portion 22a having an outer diameter corresponding to that of the casing 12, and a lower portion of reduced diameter defining a spigot 22b that is received inside the casing 12, the spigot 22b being configured to engage an inner surface of the casing 12 to retain the upper separator assembly 18 on the casing 12.

The upper support plate 22 includes a relatively small trapezoidal opening that defines an outlet 24 of the housing of the separator 10, which defines an outlet axis that is parallel to the central axis 14 of the separator 10. When the separator 10 is in use in the device, the outlet 24 discharges a filtered flow from the separator 10 that is conveyed by suitable connections to additional purification stages within the device. For example, the outlet 24 may deliver the flow to a cyclone pack that acts as a second separator stage.

Directly adjacent to the outlet 24, a second, relatively larger opening defines an entrance 26 to a fine dust collector that is integrated with the upper support plate 22 and accommodated within the separator 10, as described later.

The lower separator assembly 20 includes a generally circular lower support plate 28 that engages the lower end of the casing 12. The lower support plate 28 is coupled to the casing 12 by a hinge (not shown) that enables the lower support plate 28 to pivot between an open position, in which the lower support plate 28 is disengaged from the casing 12, and a closed position, in which the lower support plate 28 engages and closes the lower end of the casing 12. The lower support plate 28 therefore defines a closure for the casing 12.

The lower support plate 28 includes an inlet opening 30 that defines an inlet to the housing of the separator 10, the inlet opening 30 therefore having an axis that is parallel to the central axis 14 of the separator 10. In use, the inlet opening 30 is connected to ducting within the device through which a flow of air to be filtered is pumped into the separator 10.

Accordingly, the inlet 30 and the outlet 24 of the separator 10 are disposed at opposed longitudinal ends of the casing 12.

The upper separator assembly 18 further includes a mesh assembly 32 that is mounted to the underside of the upper support plate 22 directly beneath the outlet 24. The mesh assembly 32 includes a mesh support defined by a pair of parallel, planar, triangular mesh support walls 34 that extend axially downwardly from an underside of the upper support plate 22 into the casing 12. Each mesh support wall 34 has a support edge 36 corresponding to a hypotenuse of the triangle, the support edge 36 being inclined relative to the central axis 14 and extending from a rear portion of the housing on one side of the central axis 14 to a front portion of the housing on an opposite side of the central axis 14.

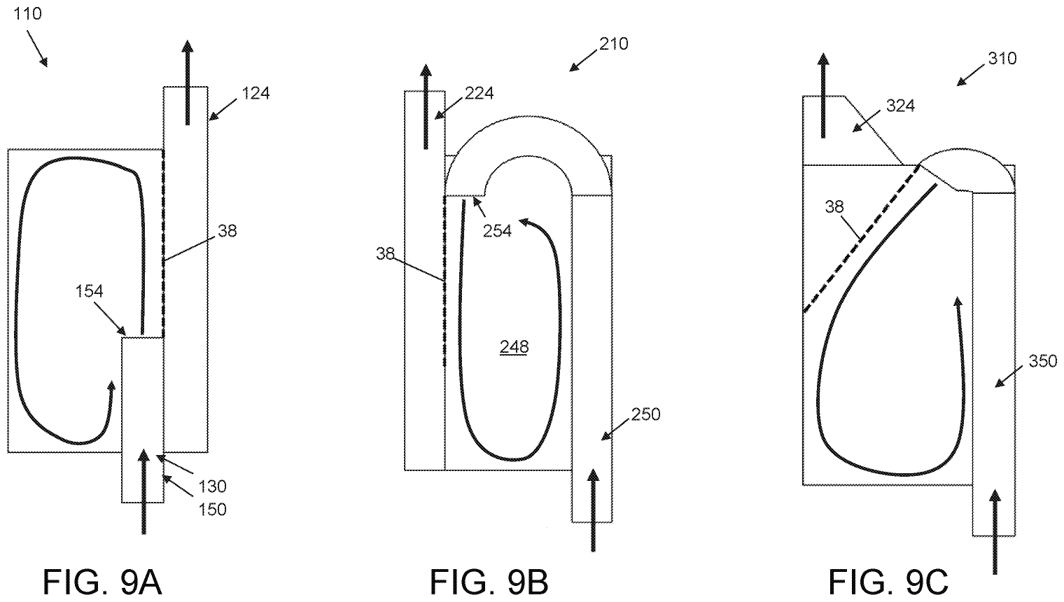

A planar, generally oblong mesh 38 is supported between the support edges 36 of the support walls 34, such that the central axis 14 intersects the mesh 38 at approximately its centre and at an oblique angle of approximately 45°. This inclination defines a base of the mesh 38, namely an end of the mesh 38 closest to the lower end of the housing. Correspondingly, a top of the mesh 38 is defined at the end of the mesh 38 closest to the upper end of the housing. It is noted, however, that in other variants the mesh 38 may be at any orientation with respect to the central axis 14. Some examples of different layouts are shown in FIGS. 9a to 9c, which are described later.

The mesh 38 is a porous screen configured to act as a filter screen, and may have a pore size in the range of 100-500 microns, for example. The pores may have various shapes, including circular, oval or polygonal pores, for example. Rectangular pores, where used, may be oriented perpendicular to the incoming flow direction. As noted above, the profiles of the leading edges of the pores, relative to the direction of the incoming air flow, may be particularly influential with respect to the separating performance of the mesh 38, with curved profiles typically offering superior separating performance. Similarly, the upstream surface of the mesh 38 that is exposed to the incoming air flow may be curved for enhanced performance.

The mesh 38 may be formed of plastic, or from metal with the pores being chemically-etched or electro-formed. The mesh 38 may mount to the support edges 36 of the mesh support walls 34 in any suitable way. For example, the mesh 38 may slide into slots formed on inner faces of the walls.

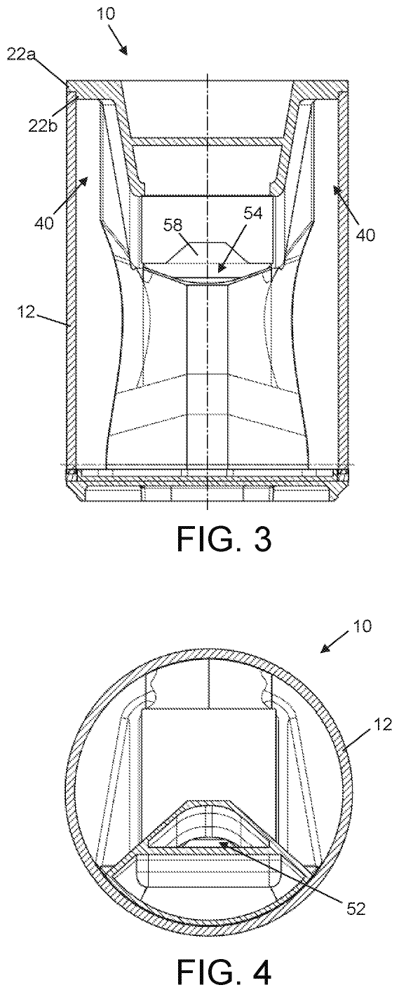

As FIG. 3 shows, the mesh 38 extends over approximately half of the diameter of the separator casing 12, such that cavities 40 are defined on each side of the mesh 38. This reduces the space that is occupied by the mesh assembly 32 and in turn increases the capacity of the separator 10 for debris. The cavities 40 also protect the mesh 38 when the separator 10 is inverted, for example when a user operates the device to clean a ceiling, by providing a space in which debris can collect around the mesh 38.

In this example, the mesh 38 has a surface area of 42cm², which the skilled person will appreciate is relatively low compared to known arrangements. This small size, in combination with the orientation of the mesh 38 and the corresponding compactness of the mesh assembly 32, minimises the proportion of the capacity of the separator volume 16 that is occupied by the mesh assembly 32.

The top of the mesh 38 adjoins an arcuate flow guide 42 that extends from the upper support plate 22, the flow guide 42 being shaped to define a flow path that leads from the top of the mesh 38, curves around the upper corner of the housing and then directs air flow downwardly along the interior of the wall of the casing 12, in use.

To the right of the mesh assembly 32, as viewed in FIG. 2, the support walls 34 of the mesh assembly 32 connect to an elongate container defining a fine dust collector 44, which is integral with, and extends downwardly from, the underside of the upper support plate 22 at the rear of the housing to engage the lower support plate 28 at the bottom of the housing. The fine dust collector 44 is therefore underslung with respect to the upper support plate 22. The fine dust collector 44 is shaped to lie against the interior of the wall of the casing 12, and encloses a volume in which fine dust that is discharged from a secondary separation stage such as a cyclone pack can collect.

The container is open at its lower end and is arranged to be closed by the lower support plate 28 when the lower support plate 28 is in its closed position. Correspondingly, pivoting or otherwise moving the lower support plate 28 to its open position allows the fine dust collector 44 to be emptied.

Above the mesh 38, as viewed in FIG. 2, a wall 45 extends from a part of the mesh assembly 32 close to the base of the mesh 38 to the central opening 24 of the upper support plate 22, the wall 45 being slightly offset from, and diverging gently upwardly from, the mesh 38. This wall 45 seals a volume behind the mesh 38 that is isolated from the fine dust collector 44, while being in communication with the outlet 24, to direct air passing through the mesh 38 to the outlet 24. This sealed space defines a secondary bin 46 of the separator 10, which in this example is in the general form of a duct that terminates at the outlet 24 of the separator 10 defined in the upper support plate 22. The wall enclosing the secondary bin 46 therefore defines a rear wall 45 of the secondary bin 46.

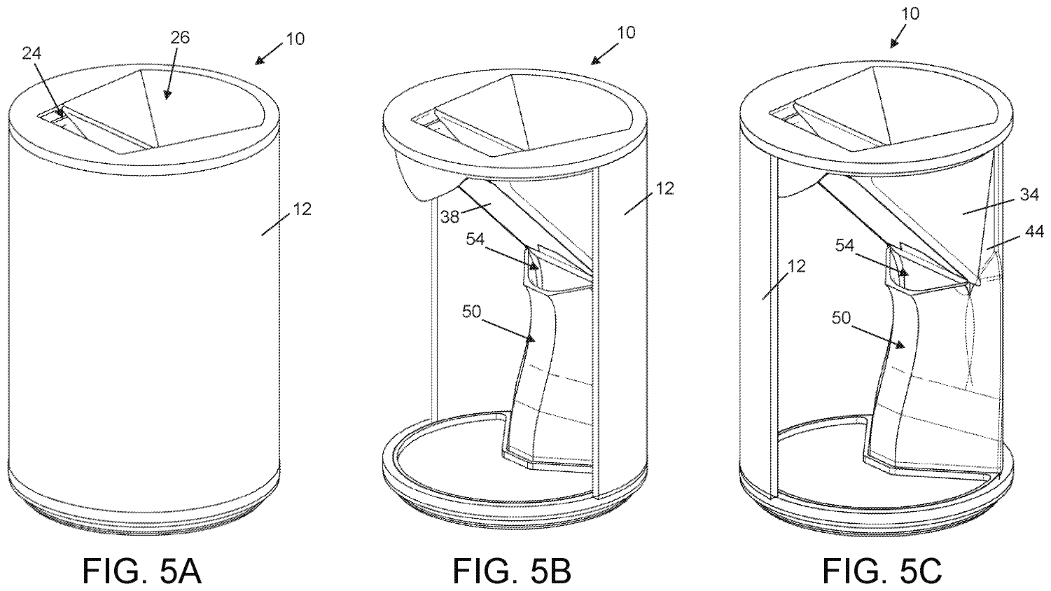

An upper end of the rear wall 45 of the secondary bin 46 therefore also separates the outlet 24 from the entrance 26 to the fine dust collector 44, as seen most clearly in FIGS. 5a to 5c. Meanwhile, the remaining parts of the volume 16 of the casing 12 outside the fine dust collector 44 and the mesh assembly 32 define the primary bin 48 of the separator 10, the primary bin 48 occupying the majority of the volume 16 of the casing 12.

The mesh 38 forms part of a boundary of a separating volume defined by the primary bin 48, such that air in the primary bin 48 must pass through the mesh 38 to reach the secondary bin 46 and the outlet 24, such that the secondary bin 46 defines a downstream chamber of the separator 10. The mesh 38 prevents particles of a certain size from passing into the secondary bin 46, so that such particles accumulate in the primary bin 48.

It is noted that moving the lower support plate 28 to its open position creates access to both the primary bin 48 and the fine dust collector 44. Accordingly, conveniently the primary bin 48 and fine dust collector 44 can be emptied together in a single operation.

The remaining space inside the casing 12 is occupied by the fine dust collector 44, which is sealed from both the primary bin 48 and the secondary bin 46. When the lower support plate 28 is closed the fine dust collector 44 is accessible only through its entrance 26 defined in the upper support plate 22, which communicates with a dust outlet of a secondary separation stage of the device upstream of the separator 10, for example a cyclone pack.

As FIG. 2 shows best, a duct is formed on top of the fine dust collector 44 by an additional wall that merges with the exterior of the fine dust collector 44, this merging being most clearly visible in FIG. 5c. The duct defines an inlet spout 50 that follows a generally upward, albeit meandering path from a spout base 52 at the bottom of the housing to terminate at a spout outlet 54 disposed at the base of the mesh 38.

As best seen in FIG. 2, a small lip 56 is formed at the radially outer edge of the spout outlet 54 where the spout 50 meets the mesh 38, the lip 56 protruding into the spout 50 and serving to guide airflow slightly away from the base of the mesh 38, to protect the mesh 38 from larger particles. For similar reasons, a trapezoidal impact plate 58 is provided at the base of the mesh 38 to cover the region of the mesh 38 that is most vulnerable to impacts from larger particles entrained in the incoming air flow.

As FIG. 4 reveals, the spout base 52 forms a trapezoidal opening that, as FIG. 2 shows, aligns with the inlet opening 30 of the lower support plate 28 when the plate 28 is closed, with a suitable seal being provided at the interface between the spout base 52 and the inlet opening 30. Accordingly, the spout 50 and the inlet opening 30 combine to form a continuous flow path for incoming air. In use, an inlet air flow entering the separator via the inlet opening 30 is conveyed along this path and discharged through the spout outlet 54 across the mesh 38 and into the primary bin 48.

The inlet air flow is drawn into the separator 10 through the spout 50 by suction induced by a vacuum motor of the device. The motor is disposed downstream of the outlet 24 of the separator 10, and therefore applies suction to the outlet 24 to create the air flow through the separator 10.

As FIG. 2 shows, the path of the spout 50 curves gently in opposed directions between the bottom of the housing and the spout outlet 54, such that the spout 50 has a swan neck profile and the spout outlet 54 is offset horizontally from, and inclined relative to, the spout base 52. In this respect, in an end portion of the spout 50 that includes the spout outlet 54 the spout 50 has an axis that is substantially parallel to the mesh 38, such that air discharged from the spout outlet 54 is directed along this path to flow across the mesh 38.

The radial depth and the circumferential width of the spout 50 are each substantially uniform along its length, so that the spout 50 has a generally constant cross section along its length. Accordingly, as FIGS. 5b and 5c show the spout outlet 54 has a trapezoidal cross section similar to that of the spout base 52.

The cross-sectional area of the spout outlet 54 is relatively large compared to similar existing arrangements, for example more than 50% larger. This reduces the speed at which air flows into the primary bin 48, leading to a pressure consumption in the primary bin 48 that may be less than half of that of existing arrangements. This in turn offers a significant improvement in the overall efficiency of the device in which the separator 10 is used.

This shaping of the spout 50 is tuned and optimised to guide the fluid conveyed through the spout 50 such that it exits through the spout outlet 54 in a direction that is substantially parallel to the surface of the mesh 38. The shaping of the spout 50 and the spout outlet 54 also causes the flow to spread out evenly across the surface of the mesh 38, such that the shape of the flow substantially matches the shape of the mesh 38 and all areas of the mesh 38 are subjected to the cleaning flow. The flat, rectangular shape of the mesh 38 further contributes to an even flow across the mesh 38.

The curves of the spout 50 each have a radius of curvature that is substantially greater than the radial depth of the spout 50, for example at least twice the depth of the spout 50, such that the 45° through which the spout 50 turns between the spout base 52 and the spout outlet 54 is spread over the length of the spout 50. Avoiding sharp turns in the inlet path helps to ensure that debris does not accumulate in the spout 50, which could otherwise cause blockages. Providing an inlet flow path that is relatively straight also minimises pressure losses in the spout 50, in turn reducing the pumping power required to convey fluid through the spout 50 and hence improving the efficiency of the cleaning device, but without risking increased mesh blinding as would be a concern in arrangements lacking the aerodynamic wiping of the present example.

It is noted, however, that the shape of the spout 50 may be varied in practice, and various shapes are possible that provide the required effect of shaping the incoming air flow with minimal pressure losses. So, for example, the spout 50 may have a single curve that extends partway or fully along the length of the spout 50, multiple curves in similar directions or multiple curves in differing directions. The spout 50 may also not have uniform depth and width along its length as in the present example.

Similarly, the spout outlet 54 may not be trapezoidal as in the present example, but may alternatively be circular, oval, rectangular or a blend of those shapes, for example. The shape that is selected is tuned to optimise spreading of the airflow across the mesh 38.

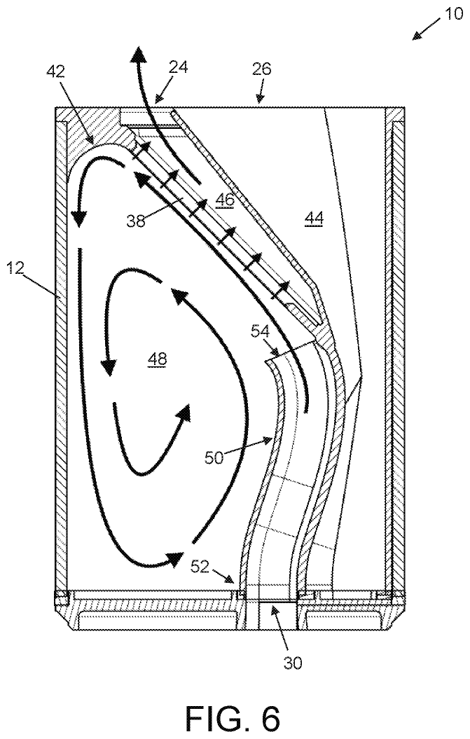

Referring now also to FIG. 6, air flowing across the mesh 38 eventually reaches the curved flow guide 42 at the top of the mesh 38, which then guides the flow around the top corner of the housing and then to flow downwardly along the periphery of the primary bin 48, as indicated by the arrows in FIG. 6. In this part of the flow, the air flows as a focussed jet with relatively high velocity. Once the air reaches the bottom of the primary bin 48 it will turn again to follow the curved exterior of the spout 50 and fine dust collector 44 to flow back up towards the mesh 38. While turning at the bottom of the primary bin 48, the flow transitions from a focussed jet to a slower, distributed flow.

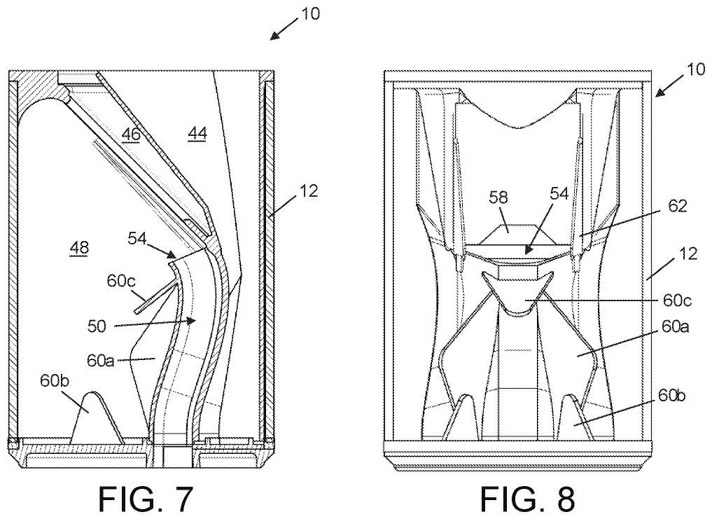

The overall effect is to create a circulatory secondary flow inside the primary bin 48 that acts to separate larger and/or heavier debris, whose momentum and weight precludes such particles being carried upwardly back towards the mesh 38, therefore causing such debris to be deposited and accumulate at the bottom of the primary bin 48. Smaller and/or lighter debris such as fluff and fibres also accumulate at the bottom of the primary bin 48, and in turn accumulated fluff and fibre can help to catch dust circulating in the secondary flow. The change in speed of the flow as it turns at the bottom of the primary bin 48 further promotes depositing of debris. Baffles and other flow guides may be included to promote depositing of particles at the bottom of the primary bin 48, as described later with reference to FIGS. 7 and 8.

Meanwhile, lighter particles that may continue to circulate with the secondary flow to return to the mesh 38 are prevented from attaching to the mesh 38 by the continuous flow across the mesh 38 from the spout 50. So, only air and particles that are smaller than the pores of the mesh 38 can pass through the mesh 38 to flow into the secondary bin 46 and on towards the outlet 24. Indeed, due to the configuration of the primary inlet flow, the separator is capable of retaining particles that are much smaller than the pores of the mesh 38 in the primary bin 48. For example, particles having a width of less than 2% of the width of the pores can be retained in the primary bin effectively.

As noted above, when the separator 10 is used in a cleaning device some of the finer particles that do pass through the mesh 38 are subsequently removed from the flow by a secondary separation stage such as a cyclone pack and trapped in the fine dust collector 44, for example via cone tips. The device may incorporate a further filter such as a HEPA filter downstream of the outlet 24 to provide a further level of purification.

To control movement of air and debris within the primary bin 48 and to promote accumulation at the base of the primary bin 48, baffles may be provided around the interior of the primary bin 48 to act as auxiliary flow guides and to resist movement of debris towards the mesh 38. FIGS. 7 and 8 show such an arrangement, in which two pairs of baffles 60 are visible: a first pair 60a extending along each side of the spout 50, and a second pair extending upwardly from positions on the lower support plate 28 to each side of the spout 50. A further baffle 60c extends from the front of the spout from a position close to the spout outlet 54. The baffles constrain air flow within the separator 10 to circulate substantially as shown in FIG. 6.

FIG. 8 also shows optional guard walls 62 that project from each support edge 36 of the mesh assembly 32, the guard walls 62 serving both to protect the mesh 38 and to constrain and guide the flow across the mesh 38.

The separator shown in FIGS. 7 and 8 is otherwise identical to that of FIGS. 1 to 5.

FIGS. 9a to 9c show, in simplified schematic form, various alternative topologies for the separator.

In FIG. 9a, a separator 110 is shown in which a mesh 38 extends vertically, an inlet spout 150 is straight and extends vertically through an inlet opening 130 into the primary bin 148 from a lower end of the bin to terminate at a spout outlet 154 that is positioned at the base of the mesh 38. Meanwhile, an outlet 124 extends from the top of the separator 110. The inlet and the outlet 124 therefore define respective axes that are parallel to but offset from one another.

FIG. 9b shows another configuration for a separator 210 in which the mesh 38 and the outlet 224 are configured in the same way as for the configuration shown in FIG. 9a, but in which the spout 250 extends from the lower end of the primary bin 248, curves around the top of the primary bin 248 and the terminates at a spout outlet 254 at the top of the mesh 38, to discharge air downwardly across the mesh 38 in use. Notably, this spout 250 may be external to the primary bin 248 apart from the final, downwardly extending portion.

FIG. 9c shows a configuration for a separator 310 in which the inlet spout 350 and the outlet 324 are configured in a similar manner to the configuration of FIG. 9b, but in which the mesh 38 is inclined relative to the vertical. Again, the spout 350 could be predominantly external to the bin in this configuration.

FIGS. 9a to 9c therefore demonstrate the flexibility with which the spout and the mesh 38 may be configured. In each case, the spout can nonetheless be configured to shape the flow of air across the mesh 38 according to the principles set out above.

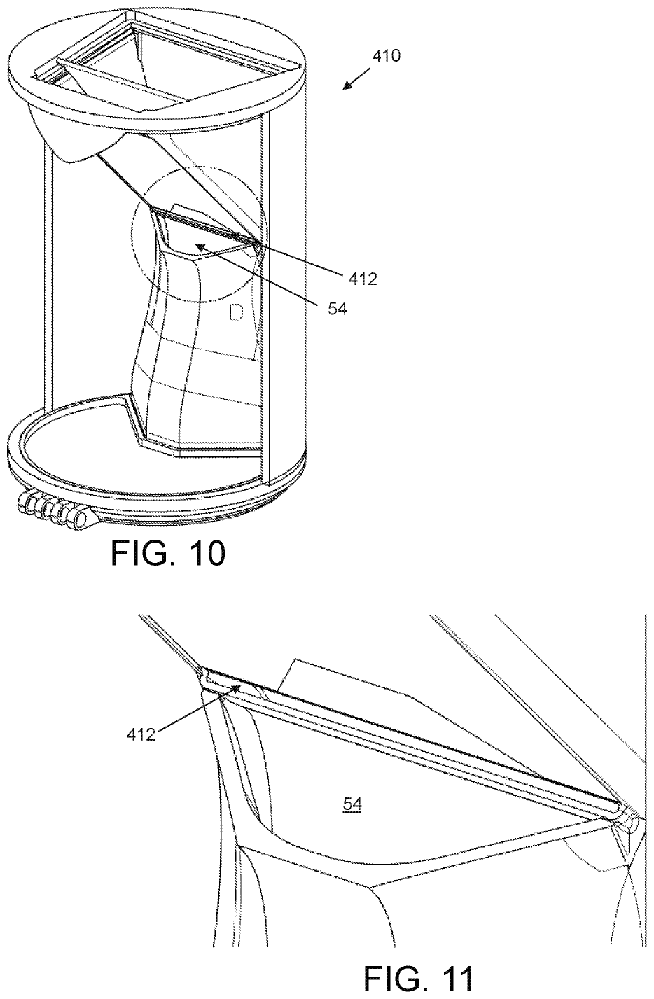

Having described the general layout of separators that are suitable for implementing embodiments of the invention above, two approaches for adapting such separators to include jet forming arrangements that provide a cleaning jet for the mesh are now described with reference to FIGS. 10 to 26.

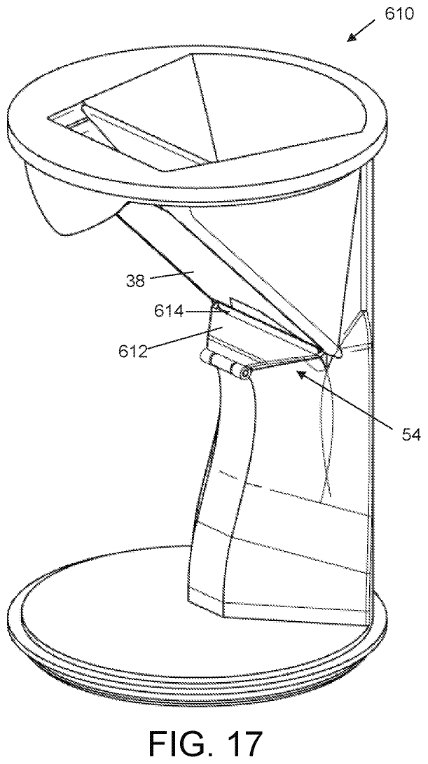

In the first approach, shown in FIGS. 10 to 16, the jet is formed using a cleaning conduit that is defined by a separate duct that extends beside the inlet spout, such that an outlet of the duct defines a jet-forming outlet. In the second approach, shown in FIGS. 17 to 26, the inlet spout itself defines the cleaning conduit, in that means are provided to constrict the spout outlet selectively to convert it into a jet-forming outlet that creates a cleaning jet when required.

In each case, the cleaning jet takes the form of a blade-like, or sheet-like, high-speed air flow that corresponds to the shape of the mesh. The cleaning jet may comprise air flowing at approximately 70 metres per second, for example, to deliver a high-power mesh clearing action.

Aside from the features associated with producing the cleaning jet, the separators shown in FIGS. 10 to 26 are otherwise substantially identical to that of FIGS. 1 to 6, and so the description that follows focusses on those features that relate to creating the cleaning jet. In particular, the main operation of the separators described below is configured in the same way as for those already described. Specifically, a primary inlet flow from the inlet spout is directed across the mesh to wash the mesh continuously, in use, the primary flow then transitioning into a circulating secondary flow within the primary bin that promotes depositing of debris at the base of the primary bin.

The cleaning jet therefore complements the continuous washing provided by the primary inlet flow, to provide more powerful cleaning action for the mesh when necessary. For example, the wiping effect of the primary inlet flow may be insufficient to clear a mesh that has started to become blocked, in which case a cleaning jet can be activated to clear the mesh quickly and then deactivated to allow the main primary flow to maintain the mesh in a cleared state.

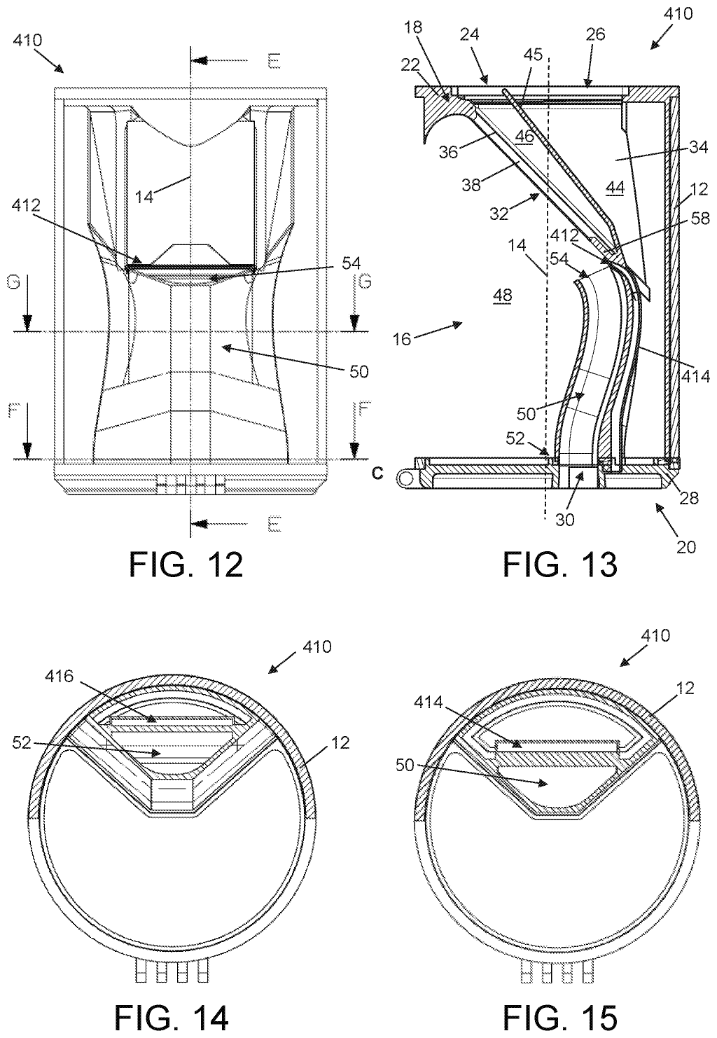

Turning, then, to FIG. 10, a first example of a separator 410 including a jet forming arrangement configured to provide a cleaning jet for the mesh 38 is shown. It is noted that FIG. 10 is substantially identical to FIG. 5c aside from one significant difference, which is more clearly visible in the detail view provided in FIG. 11; namely, a narrow, elongate slit 412 extending along a top edge of the spout outlet 54, between the spout outlet 54 and the base of the mesh 38. The slit 412 is slightly wider than the spout 50 and has a width corresponding to that of the mesh 38 in this embodiment, although in other embodiments the slit 412 may be slightly wider or narrower than the mesh 38 without compromising performance. The slit 412 defines an outlet nozzle of a jet duct 414 that is most clearly shown in FIG. 13. In this respect, FIG. 13 shows the separator 410 in axial cross-section in a central plane labelled ‘E-E’ in the front view shown in FIG. 12.

The jet duct 414 is interposed between the inlet spout 50 and the fine dust collector 44 and extends upwardly beside the spout 50. The jet duct 414 generally follows the profile of the spout 50, from a jet duct base 416 at the bottom of the housing-which is shown in the transverse cross-sectional view of FIG. 15 and acts as an intake for the jet duct 414-to the nozzle 412, which lies in a common plane with the spout outlet 54. The nozzle 412 therefore represents both a terminal end of the jet duct 414 and the jet-forming outlet in this example.

As FIG. 13 makes clear, the radial depth of the jet duct 414 is significantly less than that of the inlet spout 50, in this example being less than a quarter of the depth of the spout 50. Meanwhile, as FIGS. 14 and 15 make clear, the width of the jet duct 414 substantially matches that of the spout 50. Accordingly, the oblong cross-section of the jet duct 414 is much narrower, and thus more slit-like, than that of the spout 50. It follows that if air flow is diverted from the spout 50 into the jet duct 414, the air will travel at a much higher speed for a given mass flow rate, thereby promoting formation of the cleaning jet.

Like the spout 50, the cross-section of the jet duct 414 is substantially uniform along the majority of its length. However, the jet duct 414 reduces in depth on the approach to the nozzle 412. In this respect, a comparison between FIGS. 14 and 15 reveals the start of this narrowing at vertical level coinciding with the transverse cross-section shown in FIG. 14. The narrowing is gradual initially, but as FIG. 13 shows the jet duct 414 then narrows relatively sharply immediately upstream of the nozzle 412, which defines the narrowest point of the jet duct 414. This narrowing, in turn, accelerates an air flow conveyed towards the mesh 38, to reach a maximum speed at the nozzle 412 to form a jet.

The jet duct 414 also bends relatively sharply towards the central axis 14 on the approach to the nozzle 412, such that the upper portion of the jet duct 414 intersects an area occupied by the inlet spout 50 in the examples described above, thereby increasing the curvature of the path of the jet duct 414 in its uppermost region. This bending is counteracted by the convergence of the walls of the jet duct 414 in the immediate vicinity of the nozzle 412, which creates a short, sharp counter-bend immediately downstream of the nozzle 412.

The opposed curves of the jet duct 414, together with the funnelling induced by the constriction of the jet duct 414, act to steer and accelerate an air flow conveyed through the jet duct 414, in use, to produce a jet at the nozzle 412. In this example, the jet is directed across the mesh 38, although in other examples the jet may be directed at the mesh 38. The jet has a width dictated by the width of the nozzle 412, and therefore corresponds to that of the mesh 38. More generally, analogously to the inlet spout 50, the geometries of the jet duct 414 and the nozzle 412 are optimised to produce a jet having a shape and speed profile that ensure effective cleaning of the entire mesh 38.

Air may be delivered to the jet duct 414 via the jet duct base 416 from the same source as the inlet spout 50 or from a separate source. For example, the device in which the separator 410 is housed may be configured to deliver filtered air to the jet duct 414, so that the cleaning jet is substantially free of debris that could otherwise damage the mesh 38. For either situation, as noted above for the inlet spout 50, air is drawn through the jet duct 414 by suction induced by the motor of the device, which is downstream of the separator 410. Depending on how the device is configured to connect the jet duct 414 to an air source, the cleaning jet may be activated simultaneously with the primary inlet flow, or alternatively the cleaning jet may be activated alone, with no primary inlet flow through the inlet spout 50. In the latter option, the spout 50 may be closed through any suitable means to block the primary inlet flow, for example by operating a valve positioned at, or upstream of, the spout base 52.

Air flow through the jet duct 414 is controlled by a jet duct valve (not shown), that is operable to occlude the jet duct 414 selectively to open and close the jet duct 414. For example, the jet duct valve may be in the form of a rotatable flap, rotation of which varies the extent to which the jet duct 414 is occluded. The jet duct valve is opened to permit flow through the jet duct 414 when a cleaning jet is required. For example, the cleaning jet may be activated on start-up and//or shutdown of the device. In some embodiments, the cleaning jet can be activated on demand through a user interface of the device, either in addition to or as an alternative to automated activations.

When activated, the cleaning jet may be delivered for a short period, for example in the order of a few seconds, to dislodge debris from the mesh 38 that the primary flow from the inlet spout 50 is unable to clear, or otherwise to ensure that the mesh 38 is substantially clear before normal operation of the device proceeds.

The cleaning jet may be delivered as a continuous jet by holding the jet duct valve in a fixed open position. Alternatively, the jet duct valve may be operated to oscillate between open and closed positions to create a pulsating jet. For example, for the case where the jet duct valve is a rotatable flap, a pulsating jet may be created by rotating the flap continuously at a steady speed. Alternatively, a pulsating jet may be created by activating and deactivating the vacuum motor of the device.

A pulsating jet may provide more effective cleaning performance in some situations, especially if the cleaning jet is activated when the inlet spout 50 is closed so that there is no primary inlet flow. In this respect, when a pulsating jet is applied transient back pressure arises in the lulls between successive pulses, in that there is momentarily a higher pressure downstream of the mesh 38. As air flows into the primary bin 48 through the mesh 38 to equalise pressure across the mesh 38, debris is blown off the mesh 38 and into the primary bin 48. Accordingly, a pulsating jet dislodges debris from the mesh 38 in two different ways. It has been found that the frequency of such oscillation need be no higher than one Hertz for the pulsed cleaning to be effective.

The transient back pressure that arises when the inlets to the primary bin 48 are closed may be amplified by deactivating the device motor simultaneously. In this respect, the motor, when active, counteracts any transient backpressure to some extent, whereas deactivating the motor allows air to flow freely in the reverse direction, namely through the mesh 38 and into the primary bin 48.

This effect may also be employed in an unblocking sequence that may precede activation of a continuous or pulsating jet. In this respect, as the mesh 38 becomes blocked air flow through the separator 410 reduces for a given motor output. This, in turn, reduces the power that can be achieved for the cleaning jet, which relies on flow through the outlet 24 of the separator 410 drawn by the device motor. Once the mesh 38 is entirely blocked, it may not be possible to generate a cleaning jet effectively. In this situation, the unblocking sequence can be deployed to unblock the mesh 38, at least partially, to enable the cleaning jet to re-establish.

The unblocking sequence involves an initial step of closing both the inlet spout 50 and the jet duct 414 to prevent any flow into the primary bin 48. With the spout 50 and jet duct 414 closed, the device motor is then operated to evacuate air from the primary bin 48 to establish a full or partial vacuum in the primary bin 48. Then, with the inlets still closed, the motor is either deactivated or is allowed to choke, at which point air rushes back through the outlet 24 of the separator 410 and into the primary bin 48, through the mesh 38, to equalise pressure in the primary bin 48 with ambient pressure. This rushing of air generates a transient impulse of high intensity. For example, the peak backflow speed into the primary bin 48 may reach 200 metres per second or more. This impulse effectively unblocks the mesh 38 by dislodging at least some of the trapped debris. This, in turn, allows some air flow through the mesh 38, enabling the cleaning jet to be activated subsequently to remove any remaining debris and thereby clean the mesh 38 fully.

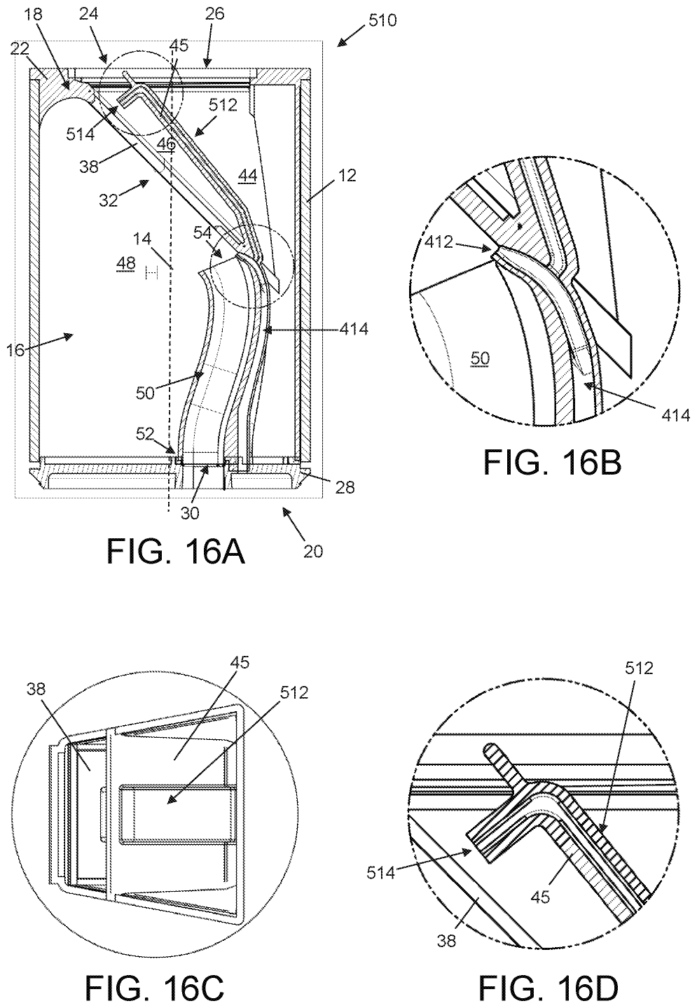

FIGS. 16a to 16d show a variant 510 of the arrangement shown in FIGS. 10 to 15, which is substantially identical to that of FIGS. 10 to 15 aside from the addition of a further jet duct 512 that branches from the main jet duct 414 near the base of the mesh 38. As the longitudinal cross-section of FIG. 16a shows, the further jet duct 512 is routed around the mesh 38 and into the secondary bin 46, to define a further jet duct outlet 514 that is configured to direct an auxiliary cleaning jet at the downstream side of the mesh 38. The branch region where the further jet duct 512 connects to the main jet duct 414 is shown more clearly in the detail view of FIG. 16b.

In this example, the further jet duct 512 is formed onto the rear wall 45 of the secondary bin 46. As the top view of FIG. 16c makes clear, the further jet duct 512 is primarily formed on an upper side of the rear wall and therefore outside the secondary bin 46, and has a width that is approximately half that of the mesh 38. The further jet duct 512 bends through a right angle close to the top of the separator 510 and shortly before the further jet duct outlet 514, to define an end portion of the further jet duct 512 that penetrates the rear wall of the secondary bin 46 and extends into the secondary bin 46, as shown in the detail view of FIG. 16d. The end portion terminates a short distance from the downstream side of the mesh 38, defining the further jet duct outlet 514.

It is noted that the dimensions and geometry of the further jet duct 512 shown in FIGS. 16a to 16d are purely illustrative and may vary in practice. For example, the further jet duct 512 may have any width up to the width of the mesh 38, and the angle and position of the end portion of the further jet duct 512 may vary considerably.

The auxiliary cleaning jet produced by the further jet duct 512 may be highly effective in terms of dislodging debris from the upstream side of the mesh 38 by concentrating a cleaning flow onto a small area of the mesh 38, thereby clearing that area when required.

In this respect, as the mesh 38 becomes blocked, resistance to air flow through the mesh 38 increases. Although the further jet duct 512 presents a relatively high resistance to flow due to its constricted geometry, as the mesh 38 becomes progressively blocked a point is reached where the mesh 38 presents a higher resistance to flow than the further jet duct 512. In this situation, incoming air naturally favours the path of least resistance and so flows predominantly through the further jet duct 512 instead of through the primary bin 48, so that the further jet duct 512 acts as a bypass route through which the device motor can draw air. This activates the auxiliary cleaning jet, which is directed onto the downstream side of the mesh 38. This in turn generates dynamic pressure on the small portion of the downstream side of the mesh 38 at which the auxiliary cleaning jet is directed, which pressure dislodges debris and thereby unblocks this portion of the mesh 38. Clearing this portion of the mesh 38 allows flow through the primary bin 48 and the mesh 38 to resume, meaning the main cleaning jet on the upstream side of the mesh 38 can be activated to clean the mesh 38 fully.

Once flow through the primary bin 48 resumes, the bypass flow through the further jet duct 512 will naturally cease due to the higher resistance to flow that it presents relative to the primary bin 48 and the recently unblocked mesh 38. However, if necessary the further jet duct 512 is optionally closed using a suitable valve to prevent continued bypass flow entirely and thereby ensure that all air flows through the primary bin 48. In principle, the use of a valve allows the further jet duct 512 to be enlarged to enhance the auxiliary cleaning jet in some embodiments.

Although the further jet duct 512 may not be filtered, as air only flows through it for short periods the quantity of debris that could potentially reach the secondary bin 46 through the further jet duct 512 is acceptable.

Moving on to the second approach for incorporating a cleaning jet, FIG. 17 shows a separator 610 that is configured such that the inlet spout 50 has a secondary function as a cleaning conduit that can produce a cleaning jet that is directed across the mesh 38, and thus forms part of a jet forming arrangement.

In this respect, FIG. 17 shows a spout cover 612 that is hinged to the radially inner edge of the spout outlet 54 to cover the majority of the spout outlet 54 when in the closed position as shown in FIG. 17. The size and shape of the spout cover 612 correspond to those of the spout outlet 54, so that the spout cover 612 has the general form of a trapezoidal flap that is hinged along the shorter of its parallel sides. However, the depth of the spout cover 612, namely the distance between its parallel sides, is slightly less than that of the spout outlet 54. In consequence, a portion of the spout outlet 54 at the base of the mesh 38 is uncovered even when the spout cover 612 is closed, this uncovered portion forming an elongate slit 614 that is similar in size, shape and position to the nozzle 412 of FIGS. 10 to 15.

The slit 614 that is formed when the spout cover 612 is closed acts as a jet-forming outlet in a similar manner to the nozzle 412 of FIGS. 10 to 15. In this respect, air conveyed through the inlet spout 50 is significantly constricted by the slit 614, and therefore accelerated, due to the much smaller size of the slit 614 compared to the spout outlet 54 when open. This acceleration produces a jet that can be used to clear the mesh 38 in the same way as the jet of the preceding example. In particular, the options of a pulsating jet and the times at which a jet may be activated are equally applicable to this example as to the last.

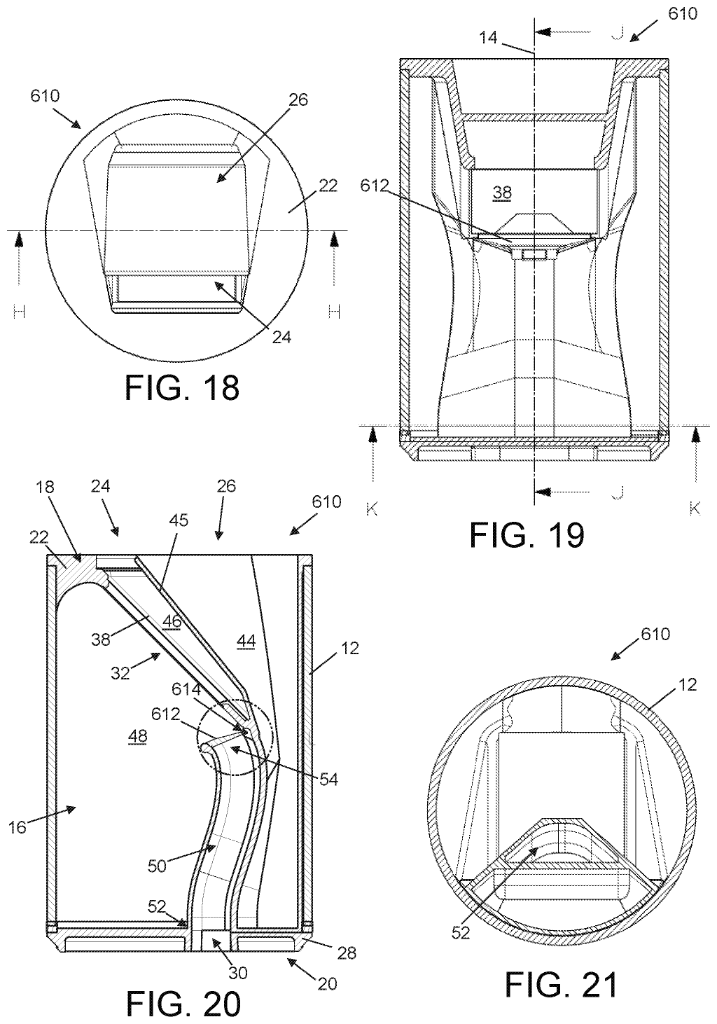

As a comparison between FIGS. 2 and 20 makes clear, aside from the presence of the spout cover 612 the separator 610 of FIG. 20 is otherwise almost identical to that of FIG. 2. In particular, the inlet spout 50 is unchanged and there is no additional jet duct as in the example of FIGS. 10 to 15. Similarly, FIG. 21 is substantially identical to FIG. 4, demonstrating that the spout base 52 is unchanged.

Since the example of FIGS. 17 to 26 does not benefit from a dedicated jet duct to control formation of the cleaning jet, in this example the slit 614 must create the jet entirely and is shaped accordingly. That said, as noted above the inlet spout 50 is already configured to direct air across the mesh 38, and so the slit 614 does not need to direct the air in that respect.

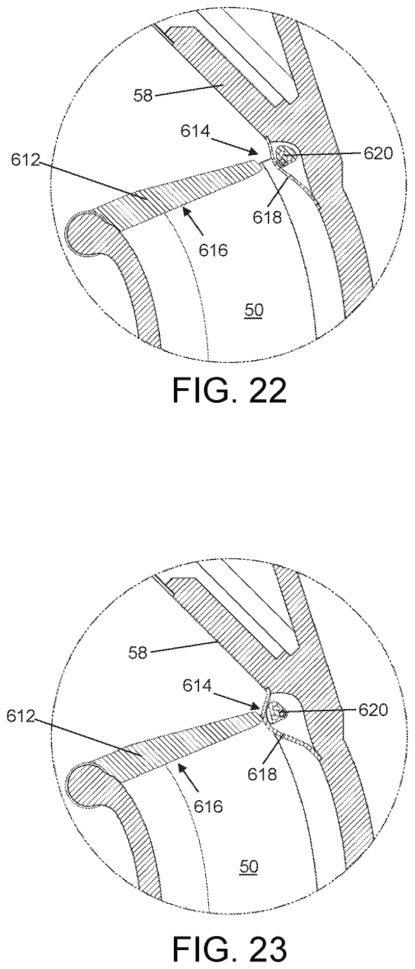

The differences that do exist relative to the separator 10 of FIGS. 1 to 6 are made clear in the detail views of FIGS. 22 and 23. FIG. 22 shows that the spout cover 612 has a planar underside 616 that extends most of the way across the spout outlet 54 towards the location at which the lip 56 is positioned in the example of FIGS. 1 to 6. The separator 610 of the present example does not include the lip, however. Instead, as FIGS. 19, 22 and 23 show, a sheet-like flexible member 618 extends across the upper end of the spout 50, and between a lower end of the impact plate 58 and an inner wall of the spout 50 at a point below the plane of the spout cover underside 616.

Behind the flexible member 618, a wedge member 620 of generally triangular cross-section is pivotably mounted at one of its corners for rotation about an axis that extends in the same plane as the spout cover underside 616, and orthogonally to the central axis 14. Rotation of the wedge member 620 induces cam-like interaction with the flexible member 618, with a first stage of rotation deforming the flexible member 618 towards the spout cover 612, followed by a second stage of rotation in which the flexible member 618 is allowed to relax and return to its rest position.

In this respect, FIG. 22 shows the flexible member 618 in its rest position, in which the slit 614 created by the spout cover 612 at the top of the spout 50 is open to permit air flow. FIG. 23 shows the wedge member 620 rotated to deform the flexible member 618, such that the flexible member 618 engages a distal end of the spout cover 612 and therefore closes the slit 614. Accordingly, FIG. 22 shows a partially open state for the spout 50, whereas FIG. 23 shows a closed state for the spout 50.

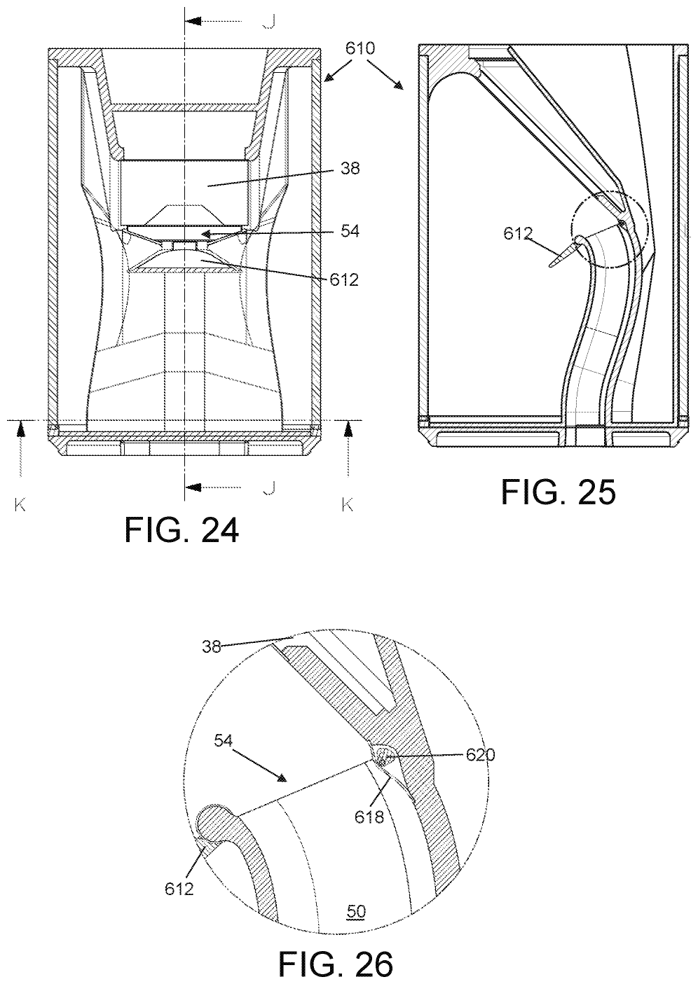

In turn, a fully open state for the spout 50 is defined by pivoting the spout cover 612 to its open position, and this state is depicted in FIGS. 24 to 26.

FIG. 26 makes clear that, when the spout 50 is fully open, the wedge member 620 is rotated to allow the flexible member 618 to assume its rest position. In this state, the profile of the flexible member 618 generally corresponds to that of the lip of the earlier separator examples. Accordingly, when the spout 50 is fully open the flexible member 618 acts to guide airflow slightly away from the base of the mesh 38, to protect the mesh 38 from larger particles, in the same way as the lip of the earlier examples.

Rotation of the spout cover 612 and the wedge member 620 can be driven in any suitable way, for example using small mechanical actuators powered by motors or servomechanisms, or pneumatic actuators.

A benefit of the second approach to incorporating a cleaning jet in the separator 610 is that there is no need for a separate, dedicated duct for forming the jet. Accordingly, complexity is reduced and manufacture is easier. Another benefit is that the spout cover 612 protects against debris falling back into the spout 50 when the device is not operating. A further benefit is that the spout 50 can be closed entirely, for example to perform the unblocking procedure outlined above when the mesh 38 is blocked.

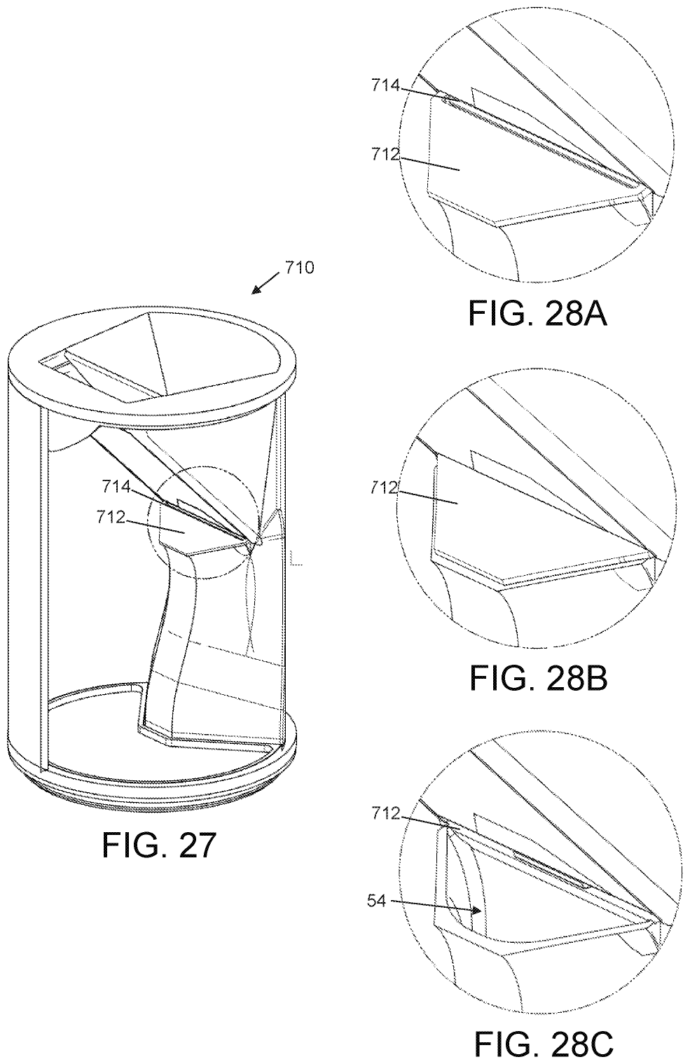

FIGS. 27 to 32 illustrate a variant 710 of the separator of FIG. 17, in which a retractable sliding spout cover 712 is used as a closure for the spout 50, instead of the pivotable spout cover 612 of FIG. 17. The spout cover 712 of FIGS. 27 to 32 is arranged for translational sliding movement across the spout outlet 54, to open and close the spout 50 when required.

The spout cover 712 is generally similar in size and shape to that of the FIG. 17 embodiment, although is slightly deeper to accommodate a spout cover slit 714, which acts as a jet-forming opening in a similar manner to the slit formed by the spout cover 612 of FIG. 17 when the spout cover 712 is positioned in a particular way.

In this respect, FIGS. 28a to 28c show that the spout cover 712 is configured to move along an axis that extends radially with respect to the separator casing 12, between three distinct positions that create corresponding respective opening states for the spout 50. In FIG. 28a, the spout cover 712 is fully deployed such that the spout cover slit 714 is exposed in a position corresponding to the position of the slit 614 of the FIG. 17 example. The position shown in FIG. 28a therefore corresponds to the partially open state for the previous example shown in FIG. 22. FIG. 28b shows the spout cover 712 partially retracted, such that the spout cover slit 714 is no longer exposed and the spout 50 is completely closed. This corresponds to the fully closed state of FIG. 23. Finally, FIG. 28c shows the spout cover 712 fully retracted in a stowed position, which opens the spout 50 fully and therefore corresponds to the fully open state for the earlier example that is shown in FIG. 26.

Movement of the spout cover 712 between the three positions shown in FIGS. 28a to 28c can be actuated in any suitable way, for example using mechanical, electrical or pneumatic actuation methods.

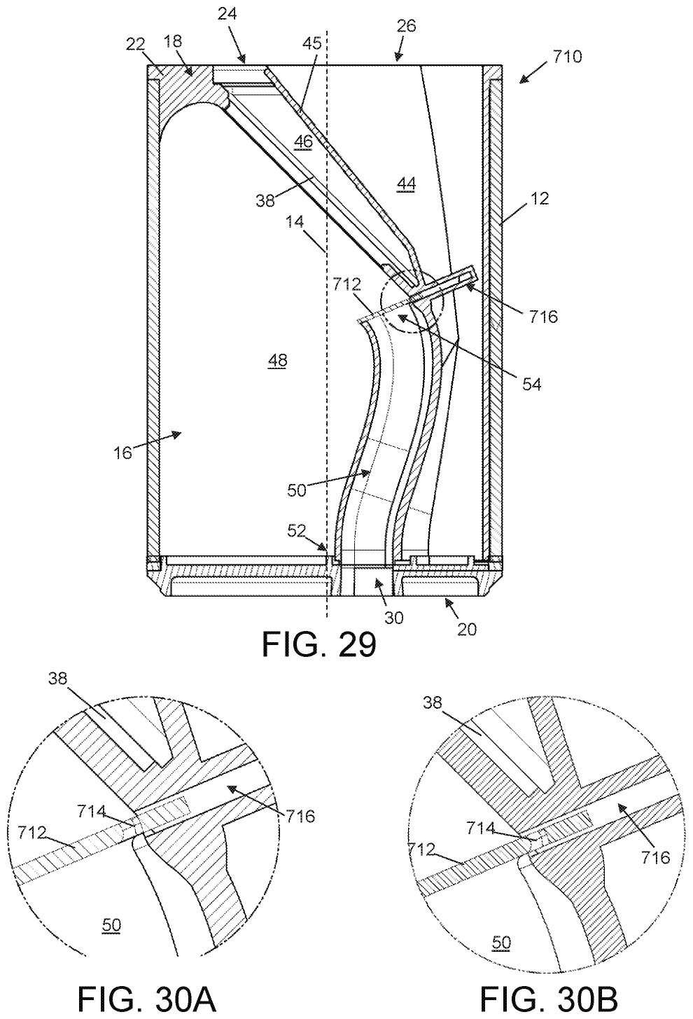

FIG. 29 shows the separator 710 in axial cross-section and so generally corresponds to FIG. 20. The example of FIG. 29 differs from that of FIG. 20 in that a cuboidal slot 716 is formed into the wall of the fine dust collector 44, in which the spout cover 712 can be stowed.

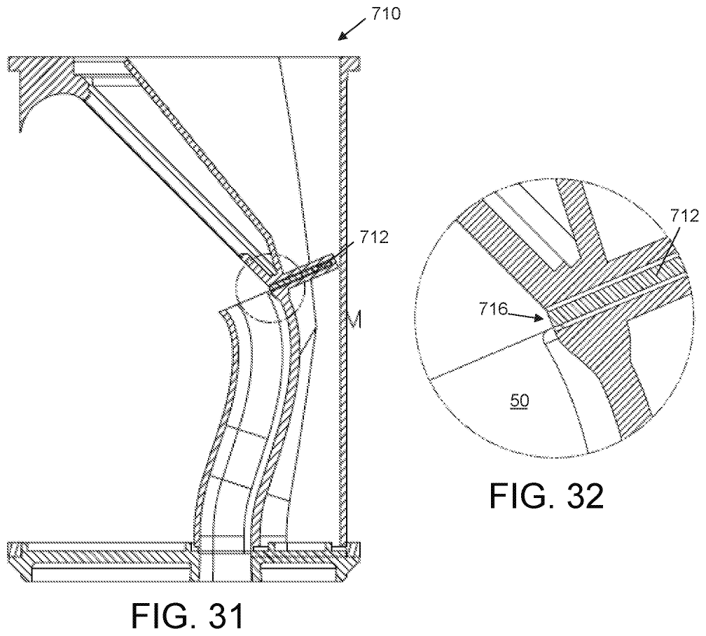

As made clear by FIG. 31, which corresponds to FIG. 29 but shows the spout cover 712 in the stowed position, the depth of the slot is substantially equal to the depth of the spout cover 712. This allows the spout cover 712 to be entirely received inside the slot when the spout 50 is in the fully open position shown in FIG. 28c.

A lower surface of the slot is coplanar with the spout outlet 54, defining a plane in which the underside of the spout cover 712 slides between its defined positions to open and close the spout 50.

FIG. 30a provides a detail view of the interface between the spout cover 712, the slot and the spout outlet 54 when the spout cover 712 assumes the partially open position of FIG. 28a. This reveals how the spout cover slit 714 aligns with a rear wall of the spout 50 in this position, thereby continuing the smooth profile of the spout wall and so aiding the formation of the cleaning jet. FIG. 30b shows the spout cover 712 partially retracted, so that the spout cover slit 714 is inside the slot and the spout outlet 54 is entirely blocked. The corresponding detail view of FIG. 32 shows that, when the spout cover 712 is in the stowed position, an end face of the spout cover 712 aligns with the wall of the spout 50 and so maintains a continuous surface profile that avoids disrupting the primary inlet flow.

The separator 710 of FIGS. 27 to 32 is otherwise identical to that of FIG. 17.

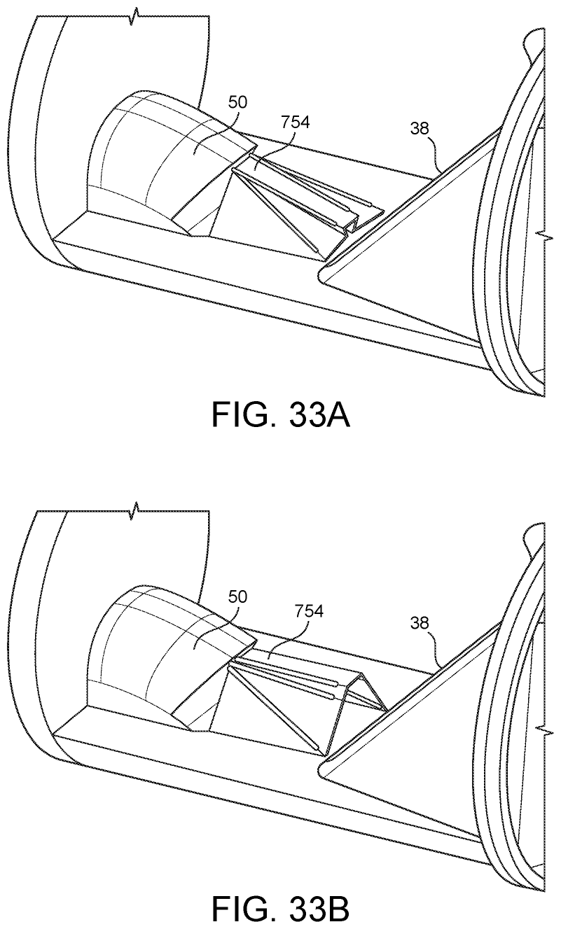

In another variant of the second approach that is shown in FIGS. 33a and 33b, instead of using a rigid cover to block part of the spout outlet, the spout outlet itself may be deformable so that its size can be varied to produce a jet when required and a primary inlet airflow at all other times. The spout outlet can be deformed to the extent necessary to create the fully open, partially open and fully closed states of the previous example. In this respect, FIG. 33a shows a deformable spout outlet 754 in a fully open configuration, and FIG. 33b shows the deformable spout outlet 754 in a partially open configuration to create a jet-forming opening.

In a further optimisation of separation performance, pressure in the lower part of the primary bin 48 may be actively reduced to promote depositing and compaction of debris at the base of the primary bin 48. This in turn reduces the extent to which debris recirculates in the primary bin 48, accumulates on the mesh 38, or even passes through to the secondary bin 46. Recirculating debris can move chaotically in the primary bin 48 and can interfere with the primary inlet flow, potentially compromising the coherence of the inlet flow that is required for effective aerodynamic washing. In turn, separation efficiency can deteriorate. Accordingly, reducing such recirculation of debris by encouraging accumulation at the bottom of the primary bin 48 has a direct impact on the performance of the separator. Increasing compaction of the debris at the bottom of the primary bin 48 may also make emptying of the bin easier for a user.

In general terms, a reduced pressure in the lower part of the primary bin 48 can be achieved through the provision of a duct or duct arrangement that creates fluid communication between the primary bin 48 and a region of the separator that is at a lower static pressure than the primary bin 48 when the device is in operation. The resulting pressure gradient between the primary bin 48 and the lower static pressure region causes air to be drawn into the duct from the primary bin 48, such that the duct acts as an extractor arrangement. Air drawn into the extractor arrangement can then be used in various ways.

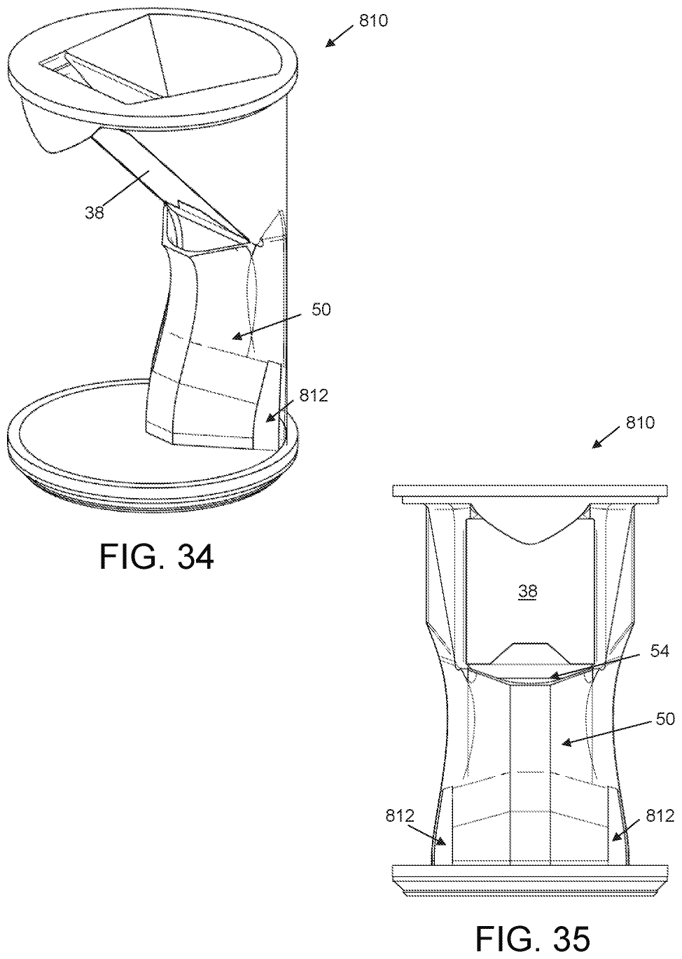

Two examples of separators including such extractor arrangements are now described with reference to FIGS. 34 to 43. In each case, aside from the features associated with the extractor arrangement, the separators of FIGS. 34 to 43 are otherwise substantially identical to that of FIGS. 1 to 6. In particular, the main operation of the separators of FIGS. 34 to 43 is configured in the same way as for those already described. Specifically, a primary inlet flow from the inlet spout 50 is directed across the mesh 38 to wash the mesh 38 continuously, in use, the primary flow then transitioning into a circulating secondary flow within the primary bin 48 that promotes depositing of debris at the base of the primary bin 48. This depositing of debris is further promoted by the extractor arrangement in the separators of FIGS. 34 to 43.

FIG. 34 shows a separator 810 that generally corresponds to that of FIGS. 1 to 6, aside from the inclusion of openings 812 in the front exterior wall of the fine dust collector 44 and the spout 50, each opening 812 extending upwardly from a lower end of the fine dust collector 44 and being elongate vertically, although it is noted that the size and shape of the openings may vary in practice. The openings are therefore spaced longitudinally from the mesh 38 in the casing 12. FIG. 35 shows that the openings are positioned symmetrically one on each side of the spout 50, at interfaces between the spout 50 and the fine dust collector 44.

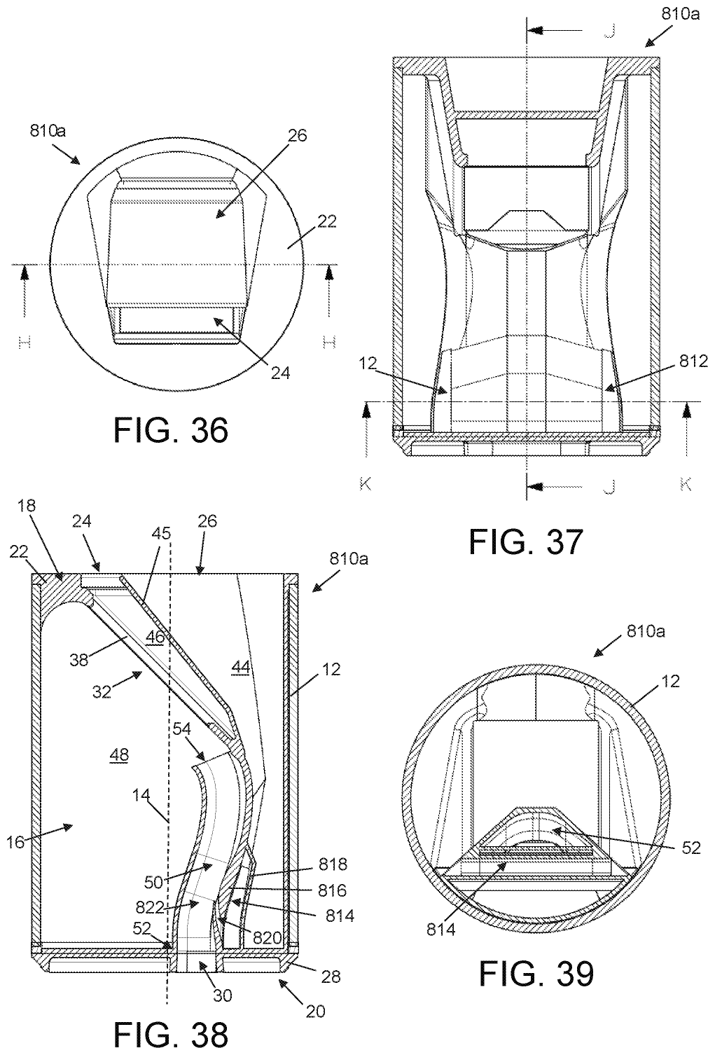

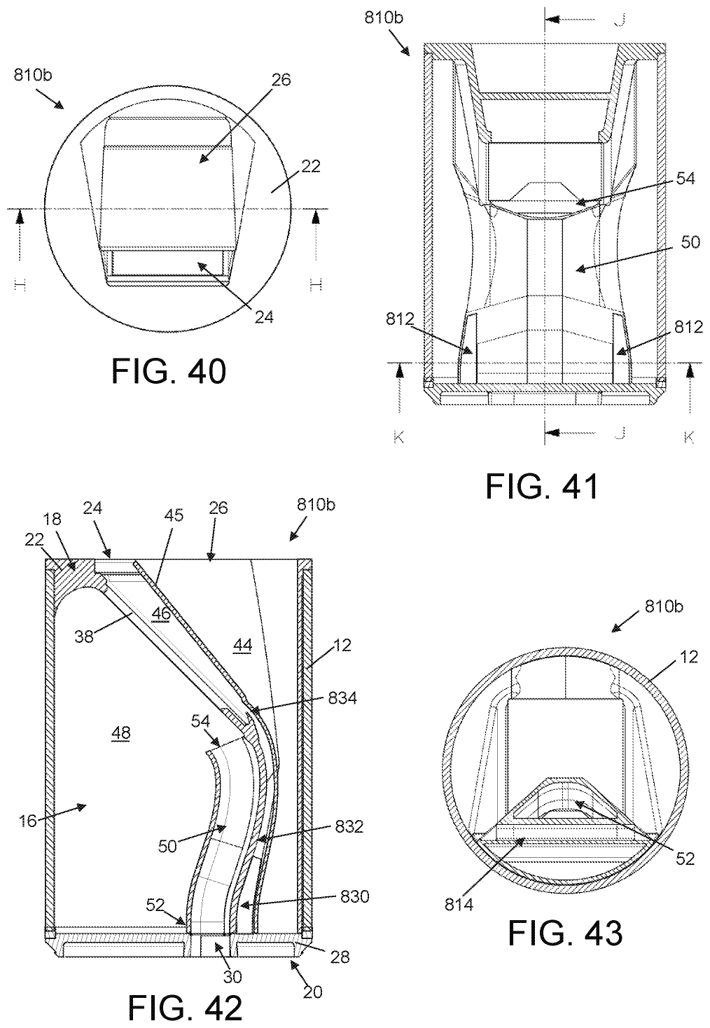

The layout shown in FIGS. 34 and 35 forms the basis for two variants 810a, 810b of separators including extractor arrangements through which air can be ejected from the primary bin 48, in which the openings 812 shown in FIGS. 34 and 35 define intakes for the extractor arrangements. The first variant 810a is shown in FIGS. 36 to 39, while the second variant 810b is shown in FIGS. 40 to 43.

Although not shown in the figures, in each variant the intakes 812 are each covered by respective filter screens that prevent debris from entering the extractor arrangement. These filter screens have pore sizes in the range of 50-500 microns, for example, and thus prevent larger debris from entering the extractor arrangement. In use, debris that accumulates at the base of the primary bin 48 covers these filter screens and so provides additional filtration to prevent smaller particles from passing into the extractor arrangement also.

In the first variant 810a, the extractor arrangement is configured to recirculate air drawn from the primary bin 48 into the spout 50, thereby creating an ejector device. In this respect, FIG. 38 shows that the intakes 812 are defined by open ends of an ejector passage 814 that extends transversely behind the spout 50, between the spout 50 and the fine dust collector 44. The boundaries of the ejector passage 814 are therefore defined by a rear wall 816 of the spout 50, a front wall 818 of the fine dust collector 44, and a lower end wall that is coextensive with a base of the fine dust collector 44.

A comparison between FIGS. 2 and 38 reveals that the space occupied by the ejector passage 814 has been recovered from space occupied by the fine dust collector 44 in FIG. 2. The spout 50 is therefore substantially the same shape in the separators 10, 810a of FIGS. 2 and 38, although the contours of the spout 50 of the separator 810a shown in FIG. 38 are slightly modified, as shall become clear from the description that follows.

FIG. 38 also shows that the rear wall 816 of the spout 50 is penetrated by a narrow passage that inclines and curves upwardly from the ejector passage 814 to the spout 50, the passage defining an ejector nozzle 820 that provides fluid communication between the spout 50 and the ejector passage 814.

Close inspection of FIG. 38 reveals that the wall of the spout 50 bulges into the spout 50 interior beneath an outlet of the ejector passage 814. In consequence, a region of the spout 50 below the outlet of the ejector passage 814 is radially constricted relative to its counterpart in the example of FIGS. 1 to 6, to define a constriction 822. Above the ejector passage 814, the spout 50 widens to resume the profile of the spout 50 shown in FIG. 2. This constriction 822 of the spout 50 creates a venturi arrangement so that, when air flows through the spout 50, low static pressure is generated directly downstream of the constriction 822 due to a corresponding increase in the flow speed caused by the constriction 822 of the spout 50. The spout 50 is configured to produce this decrease in static pressure in a region coinciding with the position of the outlet of the ejector nozzle 820.

It is noted that the curvature of the spout wall remains smooth and gentle even around the region of the bulge that creates the constriction 822 and the venturi arrangement.

Accordingly, the spout 50 is configured to avoid creating turbulence in the primary inlet flow and thereby minimise losses.

Accordingly, the ejector passage 814 and the ejector nozzle 820 connect the primary bin 48 to a region of lower static pressure, so that the ejector passage 814, the ejector nozzle 820 and the constricted spout 50 define an ejector device including a venturi. In turn, the ejector device, including its venturi, represents the extractor arrangement in the first variant 810a shown in FIGS. 36 to 39.

Static pressure in the primary bin 48 is higher than in the venturi defined by the constriction 822 of the spout 50, particularly in the lower part of the primary bin 48 where the flow is slowest. Accordingly, connecting the lower part of the primary bin 48 to the low pressure region of the spout 50 created by the venturi through the extractor arrangement naturally generates a flow, as air moves from the relatively high static pressure in the primary bin 48 to the relatively low static pressure in the spout 50. In this respect, a pressure differential is created between the ends of a flow path of the extractor arrangement extending from the primary bin 48 to the constriction 822 of the spout 50, this pressure differential generating a suction effect that draws air into the ejector passage 814 from the primary bin 48.

The geometry of the spout 50 and the ejector nozzle 820 can be tuned to optimise the suction effect for each application. In this example, the extractor arrangement is configured to recirculate approximately 12% of the air entering the primary bin 48.

In this way, the extractor arrangement is configured as a vacuum ejector, or venturi ejector, that generates suction in the lower region of the primary bin 48, in use, to draw air from the primary bin 48 into the ejector passage 814 and to recirculate that air, via the ejector nozzle 820, through the spout 50 and back across the mesh 38. This recirculation increases the flow rate of the primary inlet flow, but not the flow rate through the mesh 38, and therefore amplifies the intensity of the aerodynamic washing effect provided by that flow. In turn, the extent to which the mesh 38 is kept clear of debris in use is enhanced, as is the separation efficiency.

Also, the suction generated at the bottom of the primary bin 48 by the extractor arrangement acts to promote depositing of debris and therefore reduces recirculation of that debris around the primary bin 48. This, in turn, enhances the separation efficiency of the separator 810a.

Conversely, recirculation of air and the effective increase in the flow rate of air through the primary bin 48 increases pressure consumption in the primary bin 48, which may be approximately 15-25% higher than for the arrangement shown in FIGS. 1 to 6 for example. This must therefore be balanced against the performance gains achieved through control of debris in the primary bin 48 for the first variant 810a.

Turning now to FIGS. 40 to 43, a separator 810b representing the second variant is shown. In this variant, the extractor arrangement is defined by a bypass duct arrangement that routes air extracted from the primary bin 48 directly to the secondary bin 46.

The bypass duct arrangement includes a bypass cavity 830 extending between the intakes 812 behind the spout 50, the bypass cavity 830 being similar to the ejector passage 814 of FIGS. 36 to 39. However, the second variant 810b does not include the ejector nozzle 820 of the first variant 810a, and so the spout 50 is isolated from the bypass cavity 830. Accordingly, the spout 50 of the second variant 810b does not include the constriction 822 of the first variant 810a, and so is identical to the spout 50 of the separator 10 shown in FIGS. 1 to 6.

Instead, as shown in FIG. 42 the bypass cavity 830 communicates with an upwardly extending bypass channel 832. The bypass channel 832 is similar in form to the jet duct 414 of the separator 410 of FIGS. 10 to 15, being radially narrow and being disposed between the spout 50 and the fine dust collector 44 to follow the profile of the spout 50 in this example. However, unlike the jet duct 414 of FIGS. 10 to 15, the bypass channel 832 shown in FIG. 42 extends around the mesh 38 and into the secondary bin 46, the bypass channel 832 having an outlet 834 at its distal end that is disposed directly above the base of the mesh 38. Accordingly, the bypass channel 832 creates fluid communication between the bypass cavity 830 and the secondary bin 46.

The bypass cavity 830 and the bypass channel 832 therefore together define the bypass duct arrangement, which represents the extractor arrangement in the second variant 810b.

The secondary bin 46, being downstream of the mesh 38 and upstream of the device motor, is at lower pressure than the primary bin 48 and the spout 50. Accordingly, in operation a pressure differential arises between the intakes 812 of the bypass cavity 830 and the outlet 834 of the bypass channel 832. This pressure differential draws air into the bypass cavity 830 from the primary bin 48, and pulls that air along a flow path created by the bypass cavity 830 and the bypass channel 832. This establishes a flow through the bypass channel 832 that is discharged through the bypass channel outlet 834 into the secondary bin 46.

The pressure differential between the secondary bin 46 and the lower part of the primary bin 48 is sufficient to generate the required suction to establish a flow through the extractor arrangement. The amount of bypass flow can be manipulated by adjusting the smallest cross section of the bypass ducting. So, unlike in the first variant 810a, no other measures are required to create a lower pressure in the second variant 810b to which the extractor arrangement connects the primary bin 48.

Accordingly, in the same way as for the first variant 810a, the second variant 810b promotes depositing and compaction of debris in the lower part of the primary bin 48 by generating suction at the intakes 812. This, in turn, helps to control air flow in the primary bin 48 and improves separation performance. The second variant 810b offers the further benefit of a lower pressure consumption compared to the arrangement shown in FIGS. 1 to 6. In addition, the overall flow through the mesh 38 is reduced due to the portion of the primary inlet flow that bypasses the primary bin 48, whilst maintaining the washing flow across the mesh 38. As the filter screens that cover the intakes 812 provide effective filtering for the bypass flow, especially once covered by dust that has accumulated in the primary bin 48, the overall effect is to provide a further improvement in separation efficiency.

As an alternative to the first and second variants 810a, 810b described above, in another approach a suction device such as an auxiliary pump may be used to create the required suction in the lower portion of the primary bin 48, the suction device therefore being connected to the extractor arrangement.

It will be appreciated that various changes and modifications can be made to the present invention without departing from the scope of the present application.

In particular, the cleaning jet arrangements and extractor arrangements described above may be combined to achieve the benefits of each of these features. For example, a separator may include both the jet duct shown in FIGS. 10 to 15 and the extractor arrangement shown in FIGS. 36 to 39. Such a separator has the capability to clear the mesh using a cleaning jet produced using the jet duct, whilst simultaneously reducing the extent to which such cleaning will be necessitated, by controlling flow within the primary bin and promoting depositing and compaction of debris using the extractor arrangement.

It is also possible to combine the extractor arrangement and the cleaning jet arrangement directly, by connecting the intakes of the extractor arrangement to a jet duct that creates a cleaning jet from air recirculated from the primary bin.

Also, although the above-described embodiments use flat meshes, in other embodiments meshes that curve around one or more axes may be used.

It may be possible to form the separator housing using a different number of separate elements. For example, the upper separator assembly could be formed integrally with the casing.

1. A separator for a cleaning device, the separator comprising:
a housing that encloses a separating volume, the housing comprising an inlet for receiving a fluid flow containing entrained debris into the separating volume, and an outlet for discharging a filtered fluid flow output from the separating volume;
a filter screen disposed on or in the housing to define part of a boundary of the separating volume, the filter screen being configured to retain the debris in the separating volume while allowing air to exit the separating volume to flow to the outlet; and
an extractor arrangement providing fluid communication between the separating volume and a low-pressure region of the separator that operates at a lower pressure than the separating volume, in use, such that fluid is drawn into the extractor arrangement from the separating volume.

2. The separator of claim 1, wherein the low-pressure region is defined by a constricted channel that is configured to generate a pressure drop, in use.

3. The separator of claim 1, wherein the low-pressure region is defined by an area disposed on a downstream side of the filter screen.

4. The separator of claim 1, wherein the extractor arrangement is connected or connectable to a suction device that is configured to draw fluid from the separating volume through the extractor arrangement, so that the extractor arrangement comprises the low-pressure region.

5. The separator of claim 1, wherein the extractor arrangement comprises a spout that is connected to the inlet, the spout comprising a spout outlet through which the fluid flow is discharged into the separating volume.

6. The separator of claim 5, wherein the spout extends into the separating volume from the inlet.

7. The separator of claim 5, wherein the spout outlet defines the inlet of the housing.

8. The separator of claim 2, wherein the extractor arrangement comprises a spout that is connected to the inlet, the spout comprising a spout outlet through which the fluid flow is discharged into the separating volume, and wherein the spout comprises the constricted channel.

9. The separator of claim 1, wherein the extractor arrangement connects to the separating chamber through an intake that is spaced longitudinally from the filter screen.

10. The separator of claim 9, wherein the intake is disposed at or near a longitudinal end of the separating chamber.

11. The separator of claim 1, wherein the extractor arrangement is arranged to promote accumulation of debris in a region of the separating volume that is spaced from the filter screen.

12. The separator of claim 11, configured to promote accumulation of debris at a longitudinal end of the separating volume.

13. The separator of claim 1, comprising a filter that is arranged to prevent debris from entering the extractor arrangement.

14. The separator of claim 1, wherein the extractor arrangement defines or forms part of a vacuum ejector.

15. A cleaning device comprising the separator of claim 1.

16. The device of claim 15, embodied as a domestic appliance.

17. A method of reducing blockage of a filter screen of a separator for a cleaning device, the filter screen being disposed on or in a housing of the separator to define part of a boundary of a separating volume enclosed by the housing, the housing comprising an inlet for receiving a fluid flow containing entrained debris into the separating volume and an outlet for discharging a filtered fluid flow output from the separating volume, wherein the method comprises establishing fluid communication between the separating volume and a low-pressure region of the separator that is at lower pressure than the separating volume, in use, to define an extractor arrangement into which fluid is drawn from the separating volume.
